(19) United States
(12) Patent Application Publication
(10) Pub. No.: US 2021/0237158 A1
(43) Pub. Date: Aug. 5, 2021

(54) THERMAL CONTROL IN LASER SINTERING

(71) Applicant: Materialise N.V., Leuven (BE)

(72) Inventors: Michele PAVAN, Leuven (BE); Piet VAN DEN ECKER, Leuven (BE); Tom CRAEGHS, Leuven (BE)

(21) Appl. No.: 17/049,770

(22) PCT Filed: Apr. 23, 2019
(86) PCT No.: PCT/US2019/028800

§ 371 Date: Oct. 22, 2020

Related U.S. Application Data
(60) Provisional application No. 62/661,443, filed on Apr. 23, 2018.

(51) Int. Cl. B22F 10/366; B22F 10/28; B22F 10/85; B22F 12/13; B22F 12/41; B22F 12/49; B22F 10/73; B33Y 10/00; B33Y 40/10; B33Y 50/02

(52) U.S. Cl. CPC B22F 10/366; B22F 10/28; B22F 10/85; B22F 12/13; B22F 12/41; B22F 2203/11; B22F 10/73; B33Y 10/00; B33Y 40/10; B33Y 50/02; B22F 12/49

(57) ABSTRACT

The present disclosure relates to computer-implemented methods for tuning parameters associated with powder bed fusion processes of additive manufacturing, such as laser sintering. Disclosed herein are methods for determining scanning strategies on the basis of information about the build material, additive manufacturing apparatus, and desired or intended features of the part.

### CROSS-REFERENCE TO RELATED APPLICATIONS

This application claims the benefit of U.S. Provisional Patent No. 62/661,443, filed Apr. 23, 2018. The content of the provisional application is hereby incorporated by reference in its entirety.

### BACKGROUND OF THE INVENTION

### Field of the Invention

The field of the invention is powder bed fusion processes in additive manufacturing. Disclosed herein are methods for tuning parameters associated with powder bed fusion processes of additive manufacturing, such as laser sintering. Build parameters may be tuned, for example, in order to control the thermal behavior of the material, and build parts from powders that have not previously been tested or used for laser sintering applications, or from used powder. The methods herein optimize the build and improve the quality and consistency of these parts.

### Description of the Related Technology

Powder bed fusion (PBF) processes belong to a category of additive manufacturing in which a thin layer of powder is dispensed over a bed of powder and either chemicals or energy are used to bind, link, melt, or fuse the thin layer of powder material according to a pattern (e.g., predetermined pattern corresponding to a design of an object). The pattern may represent a cross-sectional layer of a part (also “object”), and after iterative rounds of powder deposition and exposure to chemicals or energy, each layer adheres to the layers built before and after. Eventually the entire part is formed in an additive, layer-by-layer manner. Exemplary PBF processes include direct metal laser sintering (DMLS), electron beam melting (EBM), selective heat sintering (SHS), selective laser melting (SLM), binder jetting, inkjet 3D printing, and selective laser sintering (SLS), each of which are suited for different powder materials and different methods of applying chemicals or energy.

Among the PBF processes, selective laser sintering (SLS) is widely-used to build parts out of thermoplastic materials or composite materials. In SLS, a laser scanner controlled by a computer is used to direct a laser beam onto the layer of powder. The laser scanner traces the pattern as a set of vectors, rasters, curves such as splines, or a combination of these. Typically, the entire powder bed is held at a temperature that is near to the melting temperature of the powder material such as using a separate ambient heat source, and power from the laser beam may be used briefly and precisely to melt points of the predetermined pattern on the layer of powder. When SLS build parameters, such as powder bed temperature, hatching strategies, laser scanning speed, laser power, laser beam spot size, scanner delays, and more, are selected and tuned correctly, parts built by SLS have good mechanical and physical properties and high dimensional accuracy.

Conversely, when SLS build parameters are not optimal, problems ranging from build crashes and damage to SLS machinery to structural errors and distortion of parts may result. Many raw materials are unavailable for SLS because the build parameters for these materials cannot be optimized, for example, because it is not known or understood how to control the thermal behavior of the build material during SLS. This is a limitation of SLS, particularly when it would be advantageous to select raw materials for desired thermal or mechanical properties, and not for their ability to be processed in SLS. Processability may also be problematic in samples of used powder, which has been previously preheated in a powder bed but not sintered into a part. Structural problems like a poor surface finish may result in a part built with used powder, or even a mix of used and new powder. Because of these problems, used powder is often considered unsuitable for processing and discarded.

If build parameters could be easily tuned and optimized for specific materials, then many new raw materials, as well as samples of used powder, could be used for building parts. Unfortunately, it is challenging to identify the optimal parameters. Current methods for selecting SLS build parameters are largely dependent on qualitative, trial-and-error testing performed by individual operators. In some cases, operators build sample parts under different conditions and then test material properties of the parts to find the combination of parameters that yields the best parts. In other cases, experienced operators set and tune parameters based on their knowledge of building previous parts. Reports in the literature describe general approaches for improving part quality, such as adjusting the laser beam spot size or shape, monitoring powder bed temperatures and taking corrective actions to achieve a uniform temperature across the powder bed, or scanning an object multiple times at reduced energy. These general approaches may be beneficial but are imprecise, so there remains a need in the art for methods of determining optimal build parameters in a targeted manner, based on specific knowledge of the build material.

### SUMMARY

A first aspect of the present disclosure relates to a computer-implemented method of preparing a scanning strategy for additive manufacture of a cross-sectional layer of a build, may comprise obtaining, in a computing device, thermal properties of a build material; deriving from the thermal properties, in the computing device, a range of temperatures suitable for processing the build material for additive manufacturing; obtaining, in the computing device, physical specifications of an additive manufacturing apparatus; determining, in the computing device, a scanning strategy for the cross-sectional layer of the build, wherein the scanning strategy is configured to maintain, for each point of the cross-sectional layer of the build, from the time that the point is first scanned until all points in the cross-sectional layer of the build have been scanned, a maintenance temperature within the range of temperatures suitable for processing the build material, and wherein the scanning strategy is determined at least in part based on the physical specifications of the additive manufacturing apparatus, and controlling scanning of the build material using the additive manufacturing apparatus according to the scanning strategy in order to build the cross-sectional layer.

The thermal properties of the build material may comprise temperatures at which the build material transitions to different states. The thermal properties of the build material may comprise rates at which the build material heats or cools.

In some embodiments, the maintenance temperature may be within a range comprising an upper limit that is around a degradation temperature at which the build material degrades and a lower limit that is above a crystallization temperature at which the build material crystallizes after melting. The maintenance temperature may be within a range comprising an upper limit that is around a melting temperature at which the build material melts and a lower limit that is above a crystallization temperature at which the build material crystallizes after melting. The maintenance temperature may be within a range comprising an upper limit that is below a melting temperature and a lower limit, for example, that is above a crystallization temperature at which the build material crystallizes after melting. In some embodiments, the melting temperature and the crystallization temperature differ.

The scanning strategy may further comprise a step wherein temperature at each point of the build is increased to a second maintenance temperature. The second maintenance temperature may be within a range comprising an upper limit that is around a degradation temperature at which the build material degrades and a lower limit that is above the melting temperature of the build material.

The physical specifications of the additive manufacturing apparatus may comprise at least one of number of lasers, laser beam shape, laser beam size, minimum laser power, maximum laser power, scanner delays, and maximum scanning speed.

The scanning strategy may comprise instructions regarding at least one of a selected laser, a laser power, a laser shape, a laser beam spot size, a scan time, and a number of scans for scanning points on the cross-sectional layer of the build. In some embodiments, the scanning strategy may comprise at least one initial scan of a point to melt the build material. The scanning strategy may comprise a first scanning strategy for a first point or a first plurality of points and a second scanning strategy for second point or a second plurality of points. For example, the first scanning strategy may differ from the second scanning strategy. In some embodiments, the first plurality of points may differ from the second plurality of points in at least one of spatial location and temporal order.

In some embodiments, the first plurality of points may be a first subset of points and the second plurality of points may be a second subset of points, wherein the first subset and the second subset together form points on the cross sectional layer of the build. For example, the first scanning strategy may be a contour scanning strategy and the second scanning strategy may be a hatching scanning strategy. The first scanning strategy may be a first step of the overall scanning strategy, while the second scanning strategy may be a second step of the overall scanning strategy. The scanning strategy may further comprise a preheating scanning step, prior to the first scanning strategy and the second scanning strategy. The scanning strategy may comprise a postheating scanning step, after all other scanning strategies are complete.

The cross-sectional layer of the build may comprise cross-sections of one or more parts. For example, a plurality of cross-sectional layers of the build may together form one or more 3D parts. In some embodiments, one or more points in the cross-sectional layer of the build may not correspond to a part.

The build material may comprise recycled powder or a mix of recycled and virgin powder.

In some embodiments, the method may further comprise monitoring the scanning of the build material according to the scanning strategy.

A further aspect of the present disclosure relates to a computer-implemented method for laser sintering a cross-sectional layer of build that may comprise determining, in a computing device, a first level of power needed for scanning a plurality of points on the cross-sectional layer, wherein the first level of power raises the plurality of points to a first temperature; determining, in a computing device, a second level of power for scanning the plurality of points, wherein the second level of power maintains the plurality of points at a second maintenance temperature that is lower than the first temperature; determining a scanning strategy based on the first and second levels of power, wherein the scanning strategy is configured to bring each point in the plurality of points to the first temperature and to maintain each point at or above the second maintenance temperature, starting from a time when the point is first scanned until a time when all points in the cross-sectional layer have been scanned; and controlling scanning of build material using an additive manufacturing apparatus according to the scanning strategy in order to build the cross-sectional layer.

### BRIEF DESCRIPTION OF THE DRAWINGS

FIG. 1 is an example of a system for designing and manufacturing 3D objects.

FIG. 2 illustrates a functional block diagram of one example of the computer shown in FIG. 1.

FIG. 3 shows a high level process for manufacturing a 3D object using.

FIG. 4A is an example of an additive manufacturing apparatus with a recoating mechanism.

FIG. 4B is another example of an additive manufacturing apparatus with a recoating mechanism.

FIG. 5A shows a general workflow for building parts, according to current practice.

FIG. 5B shows a workflow for building parts, according to the present disclosure.

FIG. 6 is a process by which build material, information about process behavior of the build material, desired features of a part, and physical specifications of an AM apparatus may be used to set process parameters for building a part.

FIG. 7 is a set of additional steps whereby process parameters are used to build a part.

FIG. 8 is a process for using thermal properties of a build material to determine a scanning strategy for building a part.

FIG. 9 shows a thermal curve of a point on a cross-sectional layer of a build, in which temperature is plotted as a function of time.

FIG. 10 shows a snapshot of a scanning strategy for an exemplary cross-sectional layer at each of six different time points.

FIG. 11 shows variation in thermal curves at points in two different exemplary cross-sectional layers.

FIGS. 12A-12D show vectors in an exemplary scanning strategy and a temperature profile for a point in the scanning strategy.

FIGS. 13A-13B show how blocks of data, each representing a set of vectors, may be ordered in a scanning strategy.

FIGS. 14A-14C show how overlapping regions may lead to overheating.

FIGS. 15A-15B show the avoidance of overlapping regions in a cross sectional layer comprising islands.

FIGS. 16A-16C show examples of zoning in objects, which may contribute to a more even heat distribution and/or energy density during scanning and/or to a faster scanning.

### DETAILED DESCRIPTION OF CERTAIN INVENTIVE EMBODIMENTS

Systems and methods disclosed herein include techniques for building parts (also, “objects” or “products”) by additive manufacturing (AM), in particular, determining scanning strategies for cross-sectional layers of a build, based on information about the build material, AM apparatus, and desired or intended features of the part.

Though some embodiments described herein are described with respect to certain additive manufacturing techniques using certain building materials (e.g., metals), the described system and methods may also be used with certain other additive manufacturing techniques and/or certain other building materials as would be understood by one of skill in the art.

### Designing and Manufacturing 3D Objects

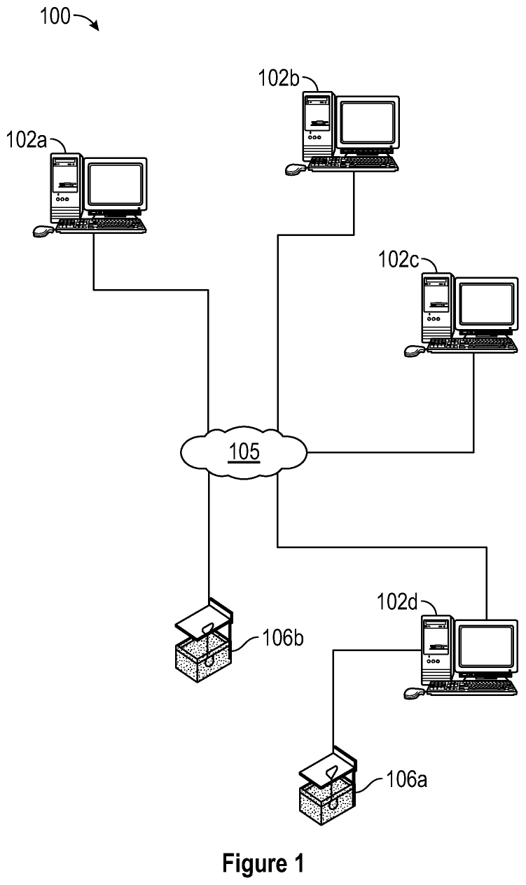

Embodiments of the invention may be practiced within a system for designing and manufacturing 3D objects. Turning to FIG. 1, an example of a computer environment suitable for the implementation of 3D object design and manufacturing is shown. The environment includes a system 100. The system 100 includes one or more computers 102a 102d, which can be, for example, any workstation, server, or other computing device capable of processing information. In some embodiments, each of the computers 102a-102d can be connected, by any suitable communications technology (e.g., an internet protocol), to a network 105 (e.g., the Internet). Accordingly, the computers 102a-102d may transmit and receive information (e.g., software, digital representations of 3-D objects, commands or instructions to operate an additive manufacturing device, etc.) between each other via the network 105.

The system 100 further includes one or more additive manufacturing devices (e.g., 3-D printers) 106a-106b. As shown the additive manufacturing device 106a is directly connected to a computer 102d (and through computer 102d connected to computers 102a 102c via the network 105) and additive manufacturing device 106b is connected to the computers 102a-102d via the network 105. Accordingly, one of skill in the art will understand that an additive manufacturing device 106 may be directly connected to a computer 102, connected to a computer 102 via a network 105, and/or connected to a computer 102 via another computer 102 and the network 105.

It should be noted that though the system 100 is described with respect to a network and one or more computers, the techniques described herein also apply to a single computer 102, which may be directly connected to an additive manufacturing device 106.

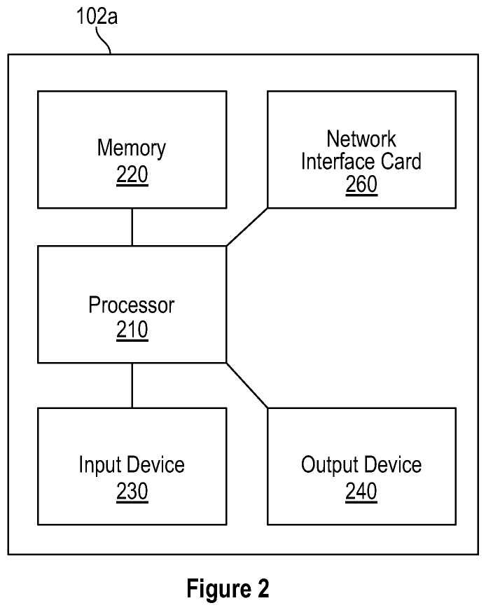

FIG. 2 illustrates a functional block diagram of one example of a computer of FIG. 1. The computer 102a includes a processor 210 in data communication with a memory 220, an input device 230, and an output device 240. In some embodiments, the processor is further in data communication with an optional network interface card 260. Although described separately, it is to be appreciated that functional blocks described with respect to the computer 102a need not be separate structural elements. For example, the processor 210 and memory 220 may be embodied in a single chip.

The processor 210 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 210 can be coupled, via one or more buses, to read information from or write information to memory 220. The processor may additionally, or in the alternative, contain memory, such as processor registers. The memory 220 can include processor cache, including a multi-level hierarchical cache in which different levels have different capacities and access speeds. The memory 220 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 210 also may be coupled to an input device 230 and an output device 240 for, respectively, receiving input from and providing output to a user of the computer 102a. Suitable input devices include, but are not limited to, a keyboard, buttons, keys, switches, a pointing device, a mouse, a joystick, a remote control, an infrared detector, a bar code reader, a scanner, a video camera (possibly coupled with video processing software to, e.g., detect hand gestures or facial gestures), a motion detector, or a microphone (possibly coupled to audio processing software to, e.g., detect voice commands). Suitable output devices include, but are not limited to, visual output devices, including displays and printers, audio output devices, including speakers, headphones, earphones, and alarms, additive manufacturing devices, and haptic output devices.

The processor 210 further may be coupled to a network interface card 260. The network interface card 260 prepares data generated by the processor 210 for transmission via a network according to one or more data transmission protocols. The network interface card 260 also decodes data received via a network according to one or more data transmission protocols. The network interface card 260 can include a transmitter, receiver, or both. In other embodiments, the transmitter and receiver can be two separate components. The network interface card 260, can be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein.

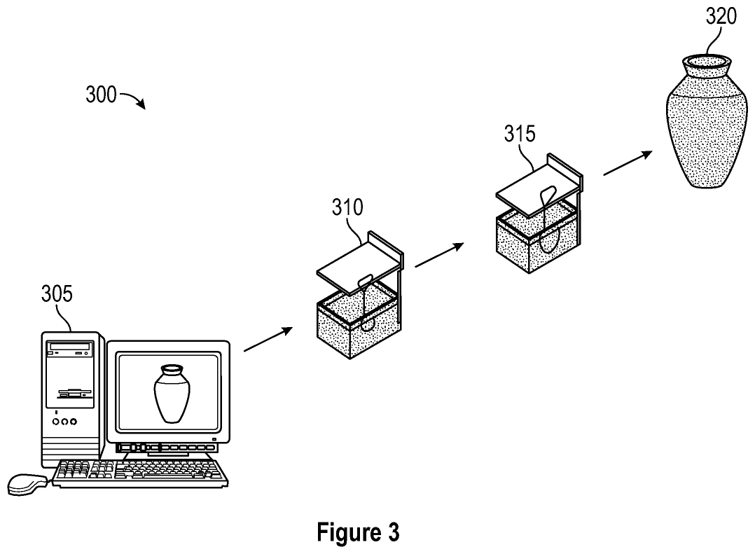

FIG. 3 illustrates a process 300 for manufacturing a 3-D object or device. As shown, at a step 305, a digital representation of the object is designed using a computer, such as the computer 102a. For example, 2-D or 3-D data may be input to the computer 102a for aiding in designing the digital representation of the 3-D object. Continuing at a step 310, information is sent from the computer 102a to an additive manufacturing device, such as additive manufacturing device 106, and the device 106 commences the manufacturing process in accordance with the received information. At a step 315, the additive manufacturing device 106 continues manufacturing the 3-D object using suitable materials, such as a polymer or metal powder. Further, at a step 320, the 3-D object is generated.

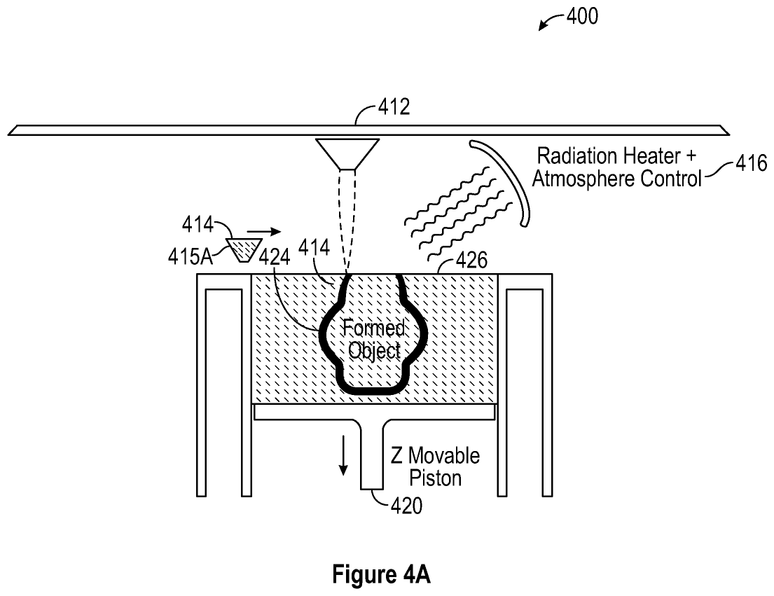

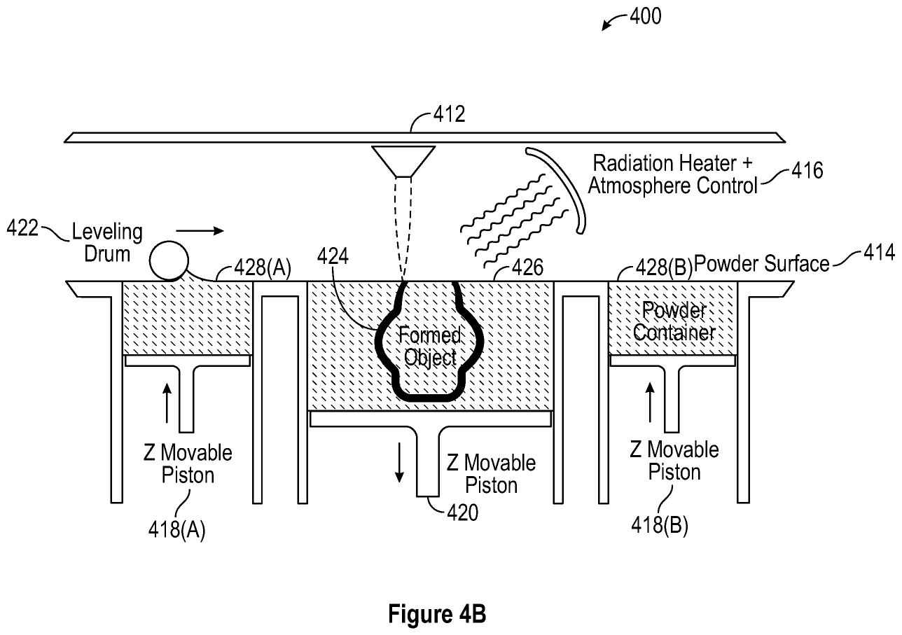

FIG. 4A illustrates an exemplary additive manufacturing apparatus 400 for generating a three-dimensional (3-D) object. In this example, the additive manufacturing apparatus 400 is a laser sintering device. The laser sintering device 400 may be used to generate one or more 3D objects layer by layer. The laser sintering device 400, for example, may utilize a powder (e.g., metal, polymer, etc.), such as the powder 414, to build an object a layer at a time as part of a build process.

Successive powder layers are spread on top of each other using, for example, a recoating mechanism 415A (e.g., a recoater blade). The recoating mechanism 415A deposits powder for a layer as it moves across the build area, for example in the direction shown, or in the opposite direction if the recoating mechanism 415A is starting from the other side of the build area, such as for another layer of the build. After deposition, a computer-controlled CO₂ laser beam scans the surface and selectively binds together the powder particles of the corresponding cross section of the product. In some embodiments, the laser scanning device 412 is an X-Y moveable infrared laser source. As such, the laser source can be moved along an X axis and along a Y axis in order to direct its beam to a specific location of the top most layer of powder. Alternatively, in some embodiments, the laser scanning device 412 may comprise a laser scanner which receives a laser beam from a stationary laser source, and deflects it over moveable mirrors to direct the beam to a specified location in the working area of the device. During laser exposure, the powder temperature rises above the material (e.g., glass, polymer, metal) transition point after which adjacent particles flow together to create the 3D object. The device 400 may also optionally include a radiation heater (e.g., an infrared lamp) and/or atmosphere control device 416. The radiation heater may be used to preheat the powder between the recoating of a new powder layer and the scanning of that layer. In some embodiments, the radiation heater may be omitted. The atmosphere control device may be used throughout the process to avoid undesired scenarios such as, for example, powder oxidation.

In some other embodiments, such as shown with respect to FIG. 4B, a recoating mechanism 415B (e.g., a leveling drum/roller) may be used instead of the recoating mechanism 415A. Accordingly, the powder may be distributed using one or more moveable pistons 418(a) and 418(b) which push powder from a powder container 428(a) and 428(b) into a reservoir 426 which holds the formed object 424. The depth of the reservoir, in turn, is also controlled by a moveable piston 420, which increases the depth of the reservoir 426 via downward movement as additional powder is moved from the powder containers 428(a) and 428(b) in to the reservoir 426. The recoating mechanism 415B, pushes or rolls the powder from the powder container 428(a) and 428(b) into the reservoir 426. Similar to the embodiment shown in FIG. 4A, the embodiment in FIG. 4B may use the radiation heater alone for preheating the powder between recoating and scanning of a layer.

### Building Parts in an Additive Manufacturing (AM) Apparatus

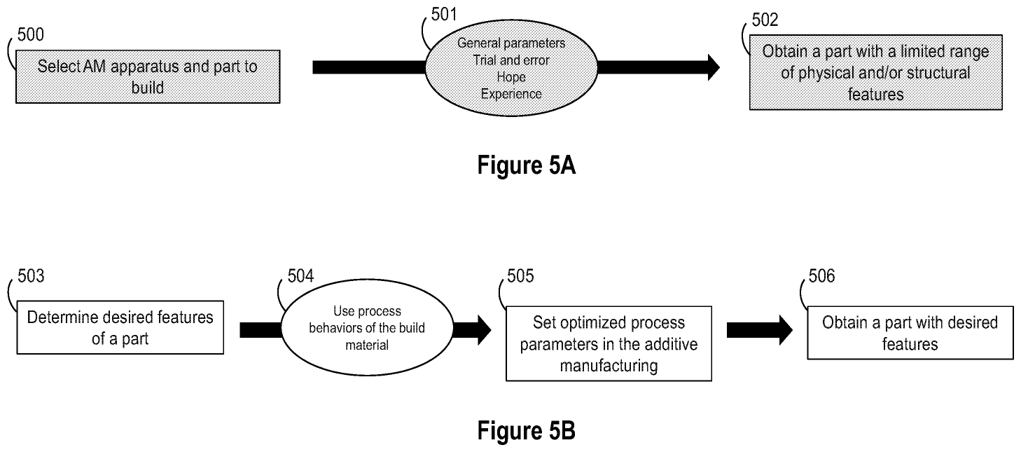

FIG. 5A shows a general workflow that is commonly used to build parts in an additive manufacturing (AM) apparatus (or “machine”). The workflow starts at 500, where an AM apparatus and a part to build are selected. A build may include a single part or a plurality of parts. Typically, an operator prepares the build, selecting from one or more process parameters including, for example, laser parameters such as laser power, beam spot size, beam spot shape, pulse time, number of pulses, and scanning speed; geometrical parameters such as hatch spacing, vector length, scan patterns, layer thickness, and number of layers; in addition to other parameters such as recoating speeds, powder bed temperature, rates of heating, and more. Conventionally, for any given build, the process parameters are selected manually in a subjective approach, based roughly on general or standard parameters used on known materials, trial and error, hope, and/or personal experience from prior builds (501). Unfortunately, the subjective approaches are usually time-consuming, especially if test parts must be built and evaluated each time process parameters are changed. In some cases, a part obtained from such a build may have a limited range of physical and/or structural features (502). For example, a part may not have a desired porosity because the process parameters required to achieve the desired porosity are not known and cannot be found. In other cases, parts cannot be built without errors, build crashes, and physical/structural defects, so build materials are deemed unsuitable for AM.

In an alternative view, many build materials may be rendered suitable for AM, if process parameters for building parts from the build materials can be readily identified. For example, process parameters may be tuned in order to control the thermal behavior (also “thermal evolution,” “temperature evolution,” or “thermal profile”) of the build material. FIG. 5B shows an example workflow according to certain embodiments of the present disclosure that implements a material-driven strategy in which process parameters may be optimized on the basis of process behaviors of the build material. The workflow may be implemented on a computing device. Starting at 503, the desired features of a part may be determined by a computing device. Exemplary features of a part may include, for example, physical and/or structural features, including but not limited to one or more of microstructure, surface finish, porosity, density, ductility, thermal conductivity, brittleness, strength, tensile strength, compression strength, shear strength, deformability, elasticity, durability, and more. If the behavior of the build material under certain processing conditions is known (“process behavior”, 504), the computing device may relate the conditions to physical and/or structural features of a part. For example, if the temperatures at which the build material melts, crystallizes, and degrades are known, and a relationship between these temperatures and physical or structural features are known, then the temperatures may be controlled during processing of the build material in order to produce a part with desired physical and/or structural features. Control of the temperatures may be an important consideration when determining optimized process parameters for an AM apparatus. At 505, the computing device uses the relationship between desired features and process behaviors in order to set optimized process parameters for the AM apparatus. The resulting built part (obtained at 506) has the desired features.

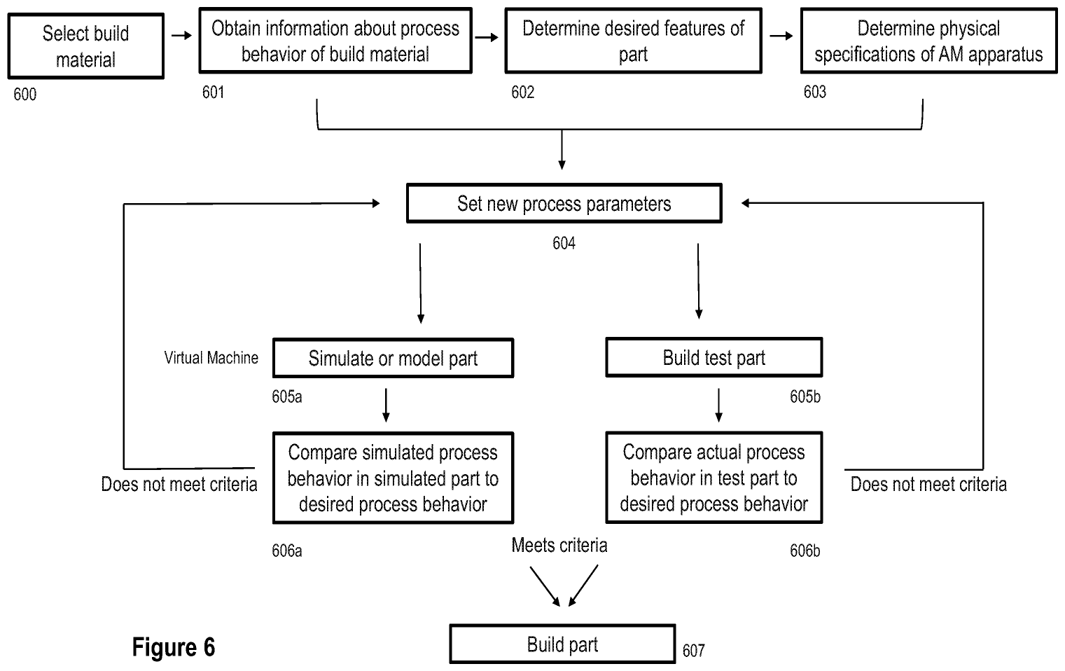

FIG. 6 shows in more detail an embodiment of an example workflow for building a part (also “object” or “printed part”), starting from a selection of build material, desired features of the part, and characteristics of the AM apparatus (“machine”) on which the object will be built. These inputs may be obtained or determined in a variety of ways and then entered into a computing device. At 600, a build material (also “material”) is selected. Build materials may be selected from liquid resins, powder, thermoplastic, metal or metal alloys, or other suitable 3-D printing materials. In some embodiments, the build material is a polymer that has been made into a powder preparation (or “polymer powder”) suitable for laser sintering. Build materials may be crystalline, semi-crystalline, or amorphous. Exemplary polymer powders comprise polyamide 12 (PA12), polyamide 6 (PA6), polyamide 11 (PA11), thermoplastic urethane (TPU), thermal plastic elastomer (TPE), polyether block amide (PEBA), polybutylene terephthalate (PBT), polyetheretherketone (PEEK), polyaryletherketone (PAEK), polypropylene (PP), polyethylene (PE), and more. The build material may comprise powder that has never been used in a build before (“unused powder”, “new powder”, or “virgin powder”), or may comprise powder that has been previously preheated but not sintered in a build (also “recycled powder,” “used powder,” “reused powder,” “aged powder,” or “thermally-aged powder”), or may comprise a mixture of virgin powder and recycled powder. For example, the build material may comprise new PA12 and recycled PA12 in a ratio of about 1:1. The build material may be a novel polymer powder that is not currently used for laser sintering, or a polymer powder that has been identified as a candidate for laser sintering due to its chemical and/or physical properties. Exemplary build materials selected for their chemical and physical properties are described in U.S. Pat. No. 9,782,932, the contents of which are incorporated by reference herein in their entirety.

One or more of particle shape, powder distribution, thermal, rheological and optical behaviors may be considered when selecting a candidate build material. Properties may be determined when a build material is subjected to measurements like one or more of differential scanning calorimetry (DSC), x-ray diffraction (XRD), thermogravimetric analysis (TGA), or when the build material is placed in build conditions like a laser sintering process. For example, viscosity of a build material may be determined by rheological measurements, while coalescence may be determined by hot stage microscopy. Features such as melting temperature, degradation temperature, crystallization temperature may be obtained from a temperature curve (or “thermal profile”) of the build material, for example, in an experimental setting like DSC or flash-DSC or during laser sintering. Other exemplary polymer properties include but are not limited to crystallinity, enthalpy of melting, zero-shear viscosity, degradation temperature, melting temperature, and crystallization temperature. In general, polymer properties may be measured under experimental conditions, but will also show variation in real-life settings. In some embodiments, polymer properties may be approximated in experimental settings and verified during an actual build. In some embodiments, polymer properties may only be determined during a build, for example, if experimental settings do not accurately represent real-life conditions.

At 601, information about the process behavior of the build material is obtained. Process behaviors relate to a build material's behavior during one or more of a variety of processing conditions, such as heating, cooling, melting, sintering, and exposure to new chemical environments. Process behaviors may reflect changes to the build material during processing, for example, changes in mechanical, chemical, electrical, thermal, optical, or magnetic properties of the build material. Process behavior may be non-linear and dependent on prior processing history.

At 602, the desired features of a part will be determined. Exemplary features of a part comprise physical and/or structural features, including but not limited to one or more of microstructure, surface finish, porosity, density, ductility, thermal conductivity, brittleness, strength, tensile strength, compression strength, shear strength, deformability, elasticity, durability, and more.

At 603, physical specifications (also “physical characteristics,” “machine parameters,” “technical specifications,” “machine specifications,” or “physical specifications”) of the AM apparatus are determined. Physical specifications, which may also be known as “machine parameters,” “technical specifications,” or “machine specifications,” may include components of the machine hardware as well as the functions and limitations of the components. Exemplary physical specification of an AM apparatus comprise one or more of number of lasers, laser beam shape, laser beam size (also “beam spot size” or “diameter”), minimum laser power, maximum laser power, scanner delays, scanning speeds (also “laser speed” e.g., maximum scanning speed, speed of scanning outlines, speed of scanning fills), build volume, build speed (e.g., mm/hr), layer thickness range, powder layout, recoater type and speed, heating system, imaging system, sensors, powder recycling and handling, material refresh rate, startup time, and more. Each AM apparatus may have a range of values for each physical specification, such as 2, 3, or 4 (or more) lasers, a plurality of laser beam shapes, a range of laser beam diameter sizes, a range of laser powers and scanning speeds that the AM apparatus may operate under, etc. A subset of physical specifications may be determined, for example, physical specifications that have an important influence on thermal behavior of the build material during processing, such as number of lasers, laser beam shape, laser beam size (e.g., diameter or spot size), minimum laser power, maximum laser power, and scanning speeds. Accordingly, one or more of laser power, laser scanning speed, laser beam shape, and laser beam size (e.g., beam diameter or beam spot size) may be adjusted and/or optimized to influence thermal behavior of the build material during processing. Physical specifications may further comprise software functions that are installed on the AM apparatus and/or recommended materials for use with the AM apparatus.

At 604, the input relating to process behavior of the build material (601), the desired physical and/or structural features of the part (602), and the physical characteristics of the AM apparatus (603) are used by the computing device to set new process parameters. The new process parameters reflect and incorporate the input (e.g., all of the input). In some embodiments, the computing device initially determines new process parameters that may already be suitable for building the part having the desired features. In some embodiments, the new process parameters are not yet the precise process parameters that are suitable for building the part with the desired features, but may be an approximation that is closer than process parameters that are obtained by starting with other methods such as trial and error, or guessing possible process parameters based on similar build materials. If a the computing device generates a limited range of possible new process parameters, then subsequent testing within the limited range, even using a trial and error approach, may be faster than starting from a broader range or a set of uninformed process parameters.

In 605 and 606, the new process parameters are tested. In 605a, the part is simulated using simulation software or modeled computationally, but an actual physical part is not built. In 606a, the computing device compares a simulated process behavior of the simulated part to desired (also “reference” or “model”) process behaviors. If the simulated process behavior meets a criteria, e.g., because measured process behaviors fall within a threshold window that is close to the desired process behavior, this may indicate that the new process parameters are suitable and may be used to build the part (607). For example, measured process behaviors may comprise thermal behaviors such as changes in state, phase, or condition of a build material as the build material heats or cools over time. The computing device may compare the simulated thermal behavior to a reference thermal behavior. If the simulated process behavior does not meet a criteria, this may indicate that the new process parameters are not suitable for building the part, and the process returns to 604, where the computing device may determine a new set of process parameters. Any data about process parameters, whether they lead to parts that process behaviors that meet criteria or not, may be stored on a computer storage medium and later used by a computing device to aid in selection and tuning of future process parameters for the same or for a different build.

In 605b, a test part is built on the AM apparatus, and the computing device compares actual process behavior of the build material to the desired process behavior. As with the simulated process behavior, if the actual process behavior meets criteria, e.g., is similar to the desired process behavior, this may indicate that the new process parameters are suitable for building the part, and the part can be built using the new process parameters (607). One exemplary method of comparing actual process behavior to a reference model is described in in WO 2016/201390, the contents of which are incorporated by reference herein in their entirety. If criteria are not met, the process returns to 604, where a new set of process parameters are determined. Any data about process parameters, whether they lead to parts and/or process behaviors that meet criteria or not, may be stored on a computer storage medium and later used by a computing device to aid in selection and tuning of future process parameters for the same or for a different build.

The steps of testing and comparing may be repeated until the simulated or actual process behaviors meet the criteria and the part is built.

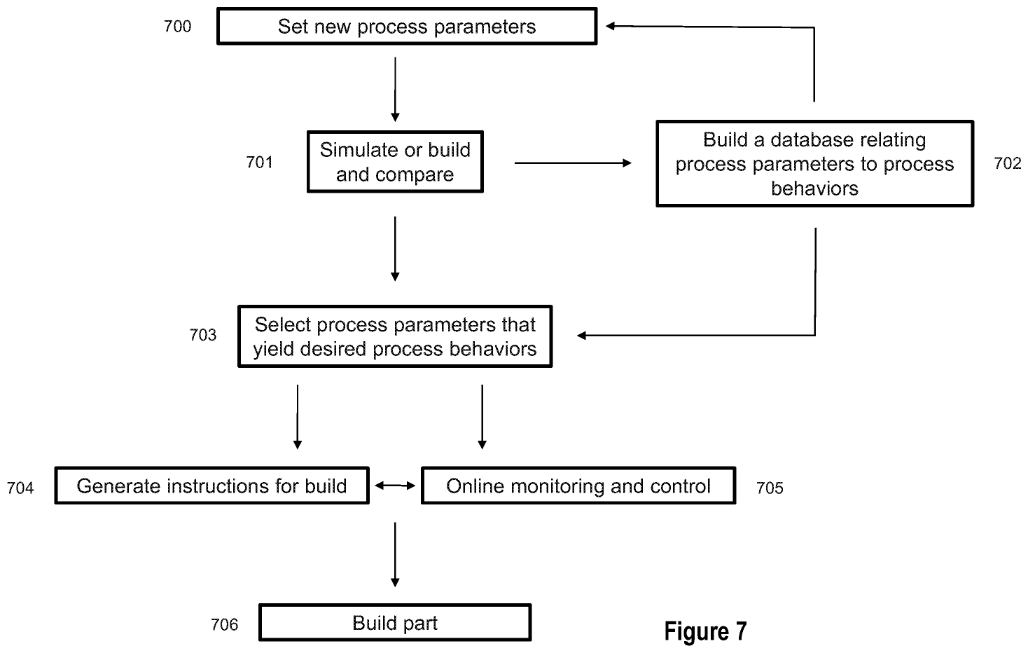

FIG. 7 illustrates an embodiment of example additional steps between setting new process parameters and building the part. In 700, new process parameters have been set. 701 refers to the simulation or build steps of 605a and/or 605b from FIG. 6, as well as the comparisons with desired process behaviors in 606a and/or 606b from FIG. 6. Data reflecting the relationship of new process parameters to process behaviors such as temperature behavior and/or desired physical and/or structural features may be stored on a computer storage medium and/or collected to build a database (702). The computing device may use information in the database to set new process parameters (604), for example, when the first process parameters tested were not suitable, or for different builds at a later time. In some embodiments, information in an existing database may be used to set the first set of new process parameters and may be the first and/or only source used by the computing device for selecting process parameters. In some embodiments, the computing device uses a combination of process parameter information from the database (702) and values from testing and comparison steps (701) in order to select process parameters suitable for building a part (703). In 704, the computing device generates instructions for building the part. In 705, the computing device provides for monitoring and control of the instructions. The computing device may monitor before the build begins and/or may monitor online during the build. The computing device may use control functions in order to take corrective measures such as revising instructions in 704, or stopping the build. The part is built on the AM apparatus in 706.

### Preparing a Scanning Strategy

As described, the preparation of a scanning strategy may comprise several steps of a computer-implemented method: first, translating polymer properties and process behaviors into process parameters, and second, translating the process parameters into a scan pattern that fulfills all requirements.

One aspect of the present disclosure relates to a computer-implemented method for preparing a scanning strategy for additive manufacture of a part. More specifically, a computing device may prepare a scanning strategy for one or more cross-sectional layers of a build. A single build may comprise one or more parts, all built from the same build material and/or all built in the same build chamber on the same AM apparatus. The parts may be nested amongst one another and/or may be spaced apart from one another in any of the x, y, and z directions. When a cross-sectional layer of the build (also “cross section of layer” or “cross section of object”) is scanned, the area scanned may correspond to a cross section of at least one part.

In some embodiments, the computer-implemented method of preparing a scanning strategy for additive manufacturing of a cross-sectional layer of a build comprises obtaining, in a computing device, thermal properties of a build material; deriving from the thermal properties, in the computing device, a range of temperatures suitable for processing the build material for additive manufacturing; obtaining, in the computing device, physical specifications of an additive manufacturing apparatus; determining, in the computing device, a scanning strategy for the cross-sectional layer of the build, wherein the scanning strategy is configured to maintain, for each point of the cross-sectional layer of the build, from the time that the point is first scanned until all points in the cross-sectional layer of the build have been scanned, a maintenance temperature within a range of temperatures suitable for processing the build material, and wherein the scanning strategy is determined at least in part on the physical specifications of the additive manufacturing apparatus; and controlling scanning of the build material using the additive manufacturing apparatus according to the scanning strategy in order to build the cross-sectional layer.

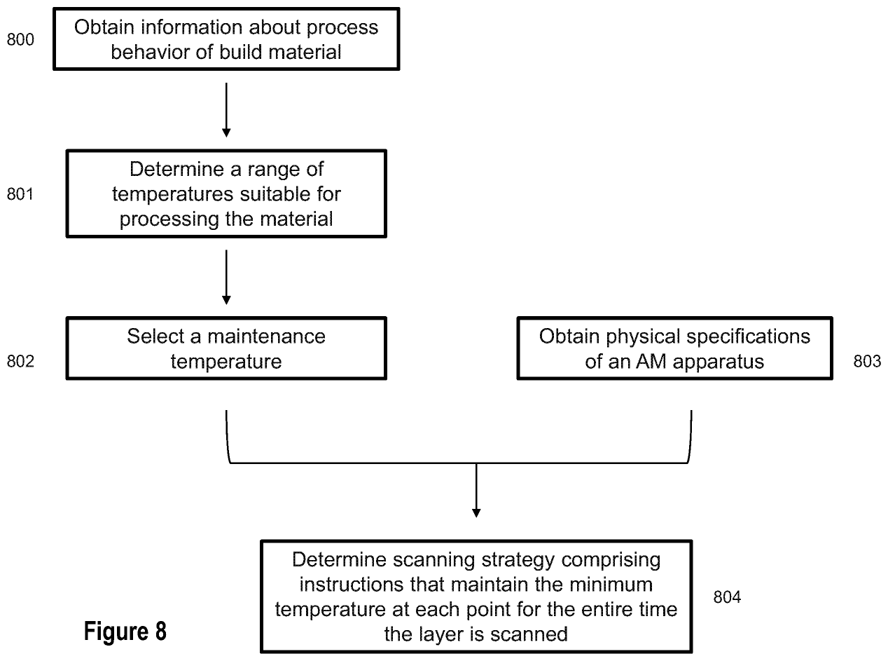

FIG. 8 illustrates an exemplary embodiment of the computer-implemented methods described herein. In 800, the computing device obtains information about the process behavior of the build material. For example, the process behavior may comprise thermal properties of the build material when exposed to different temperatures. Thermal properties may comprise temperatures at which the build material transitions to different states, phases, and/or conditions, such as the melting temperature (Tₘ) where the build material changes from solid to liquid state, the glass transition temperature (T_{g}) where the build material transitions from a hard, glassy state to a viscous state, the crystallization temperature (T_{c}) where the build material crystallizes after a melt, and/or the degradation temperature where (T_{d}) the build material degrades. Thermal properties may include one or more of rates at which the build material heats or cools, e.g., the rates at which temperatures are reached. Transitions may occur over a range of temperatures, and the rates of heating or cooling may vary for different build materials. Rates of heating and cooling may also vary due to the thermal-history of the build material. In addition, physical properties such as the particle size or packing density, and process parameters such as rate of heating/cooling of the build material, may influence the transition temperatures. Accordingly, the temperature or range of temperatures at which a build material transitions may vary in a specific sample of the build material.

On the basis of thermal properties, the computing device determines a range of temperatures suitable for processing the build material (801). For example, the build material may be heated to the melting temperature but not to the degradation temperature. The build material may be maintained at a first temperature for a given time period, or maintained at a maintenance temperature that is within a range of temperatures. In some embodiments, the computing device selects the maintenance temperature which must be maintained for each point in the build material, from the time that the point is first scanned until the time when all points in the cross-sectional layer have been scanned (802).

In some embodiments, the maintenance temperature is the melting temperature. In some embodiments, the minimum temperature is the crystallization temperature. Accordingly, the scanning strategy may be configured to maintain for each point a maintenance temperature within a range comprising an upper limit that is around the degradation temperature and a lower limit that is above a crystallization temperature at which the build material crystallizes after melting. In some embodiments, the upper limit is around the melting temperature and the lower limit is above the crystallization temperature.

The computing device obtains physical specifications of the AM apparatus (803), and may use these physical specifications to determine the scanning strategy for the build. In some embodiments, the computing device determines a scanning strategy at least in part on the physical specifications of the AM apparatus. For example, the scanning strategy may comprise instructions regarding at least one of a selected laser, a laser power, a laser shape, a laser beam spot size, a scan time, scanning pattern, scanning order, and a number of scans for scanning points on the cross-sectional layer of the build. In some embodiments, the computing device may determine a scanning strategy comprising a scanning pattern, laser scanning parameters and a scanning order that is configured to cause the build material to exhibit a process behavior, such as a thermal behavior. These instructions may be determined in a computing device that is configured to select, from available functions of the AM apparatus, the combination of scans (for example, vectors such as hatches, rasters, fills, borders, contours, edges, blocked paths, and more, or curved paths) and/or the order of scanning that will most efficiently build the cross-sectional layer. The computing device may further determine which laser to use and timing for their use for each of the scans in the scanning strategy.

The computing device may balance (e.g., all) requirements and considerations in order to arrive at the optimal combination of instructions. For example, when a scanning strategy comprises at least one initial scan to melt the build material at a point in the cross-sectional layer, the initial scan may provide enough energy for the build material to reach its melting temperature but not its degradation temperature. The instructions for scanning may modulate laser power for this initial scan by adjusting the time of the scan and/or the shape of the laser beam. A lower laser power may be used in combination with a slower scanning speed, because the time of exposure is prolonged. Similarly, the laser power could be decreased and/or the scanning speed could be increased, when beam spot has a flat-top (or “top hat”) shape that provides a more uniform energy density than a traditional Gaussian beam. Accordingly, for the initial scan, the computing device may determine a specific laser power, for a specific period of time, as mediated by a given laser beam shape and scanning speed.

In some embodiments, the scanning strategy is configured to maintain, for each point of the cross-sectional layer of the build, from the time that the point is first scanned until all points in the cross-sectional layer of the build have been scanned, a maintenance temperature within the range of temperatures suitable for processing the build material. In 804, the computing device determines a scanning strategy comprising instructions for the AM apparatus to keep the maintenance temperature at each point of the cross-sectional layer for the entire time that the layer is scanned.

The maintenance temperature may be within a range comprising an upper limit that is around the degradation temperature of the build material degrades and a lower limit that is above a crystallization temperature of the build material. The maintenance temperature may be within a range comprising an upper limit that is around the melting temperature of the build material and a lower limit that is above a crystallization temperature of the build material. In general, the maintenance temperature may be above the preheating temperature at which all build material in the build chamber is held. In some embodiments, the process of crystallization at any given point may be subjected to experimental, environmental, and kinetic factors such as rate of cooling, rate of heating, environment surrounding the point in the cross-sectional layer, or crystals remaining in the sample even after initial melting. For example, the crystallization temperature may be different under real build conditions, for example, higher than expected from approximate or experimental measurements. Accordingly, the maintenance temperature may be within a range having a lower limit that is selected based on a crystallization temperature under conservative conditions, even though some points in the cross-sectional layer may actually crystallize at lower temperatures than the maintenance temperature. In certain embodiments, the maintenance temperature may be based a range of temperatures determined under experimental conditions such as DSC, and further adjusted to account for kinetic and environmental factors.

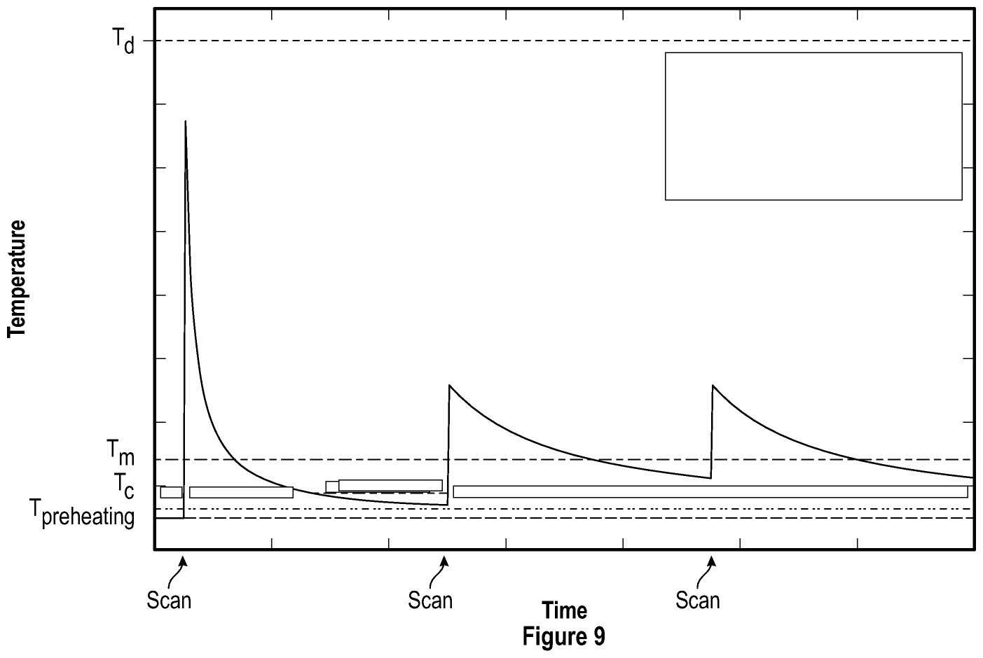

An exemplary scanning strategy determined by the computing device may comprise one initial scan of a point at a first power, followed by subsequent scans of the point in which at least one of scanning time, laser power, beam spot size, beam spot shape, or number of scans differs from the initial scan. In an AM apparatus having multiple lasers, the computing device may determine a scanning strategy that uses a first laser for the initial scan of a first point, in order to melt the build material at this first point. The first laser may then be used for initial scans on a second and a third point, up to an nth point. In the meantime, when the first point cools from the melting temperature to the maintenance temperature, a second laser may be used to provide at least one subsequent scan to the first point in order to maintain the maintenance temperature. Accordingly, the computing device may determine the time intervals during which any scanned point has received its initial scan and has cooled to its maintenance temperature, whereby the scanning strategy provides instructions for subsequent scans of the points. In some embodiments, the scanning strategy may use only a single laser for all scans, although time for building a part may be increased if a single laser is used for both the initial scan and all subsequent maintenance scans. FIG. 9 is an exemplary thermal cycle plot showing temperature at a point as function of time. On the plot, three black arrows indicate the three times that the point is scanned. After the first scan, the temperature rises above the melting temperature (Tₘ), but stays below the degradation temperature (T_{d}). When the temperature cools to the crystallization temperature (Tc), the subsequent scans maintain the temperature above T_{c}, and in this example, also above Tₘ. The preheating temperature (T_{preheating}) is also indicated on the plot. In general, the T_{preheating} may refer to a global preheating temperature that all of the build material on the build surface reaches, for example, through the action of heat lamps on the build surface. Global preheating may not be directed to any specific set of points or vectors in the cross section of the object on the build surface.

The computing device may determine a scanning strategy in which subsequent scans (whether from the same laser or from a different laser) retrace the same path of the initial scan, or the computing device may set a scanning strategy that varies the path. The subsequent scans may be angled orthogonally or at an angle less than 90° relative to the initial scan. In some embodiments, points not scanned by the initial scan may be scanned by the subsequent scans. For example, if a larger laser beam spot is used for the subsequent scans, a large area may be scanned, wherein the large area comprises one or more points that were initially scanned in addition to points that were not initially scanned. In some embodiments, the one or more points scanned may not correspond to a part. In another exemplary scanning strategy, a point may be preheated using preheating laser scanning prior to the initial scan that melts the build material at a point.

In some embodiments, the computing device determines a scanning strategy for each individual point. A first scanning strategy for a first point may differ from a second scanning strategy for a second point. For example, the first point may be scanned before the second point, so the first point has a longer time interval between an initial scan and the time that all other points on the cross-sectional layer are scanned. As a result, the first point may require a larger number of subsequent scans in order to remain at the maintenance temperature for the longer time interval. In contrast, the second point may require fewer subsequent scans in order to remain at the maintenance temperature for a shorter interval.

In some embodiments, the computing device determines a scanning strategy for a plurality of points. Points in the build may be grouped into a plurality of points based on their proximity to each other. For example, a first plurality of points in a first spatial location on the cross-sectional layer of the build may be all be scanned according to a first scanning strategy, while a second plurality of points in a second spatial location on the cross-sectional layer may all be scanned according to a second scanning strategy. Points in the build may be grouped into a plurality of points based on temporal order of scanning, e.g., time bins during which the points may be scanned. For example, during a first time bin, a first plurality of points (which may or may not be located in proximity to one another) may be scanned according to a first scanning strategy. During a second time bin, a second plurality of points may be scanned according to a second scanning strategy. During a third time bin, the first plurality of points is rescanned according to a third scanning strategy such as a scanning strategy that maintains the maintenance temperature at each point in the first plurality of points. Points in the build may be grouped into a plurality of points according to similarity of vectors (e.g., hatches, borders, fill, or edges), or according to any data blocks in which similar points may be generalized. In some embodiments, when the cross-sectional layer is viewed globally, the scanning strategies across a whole layer are heterogeneous.

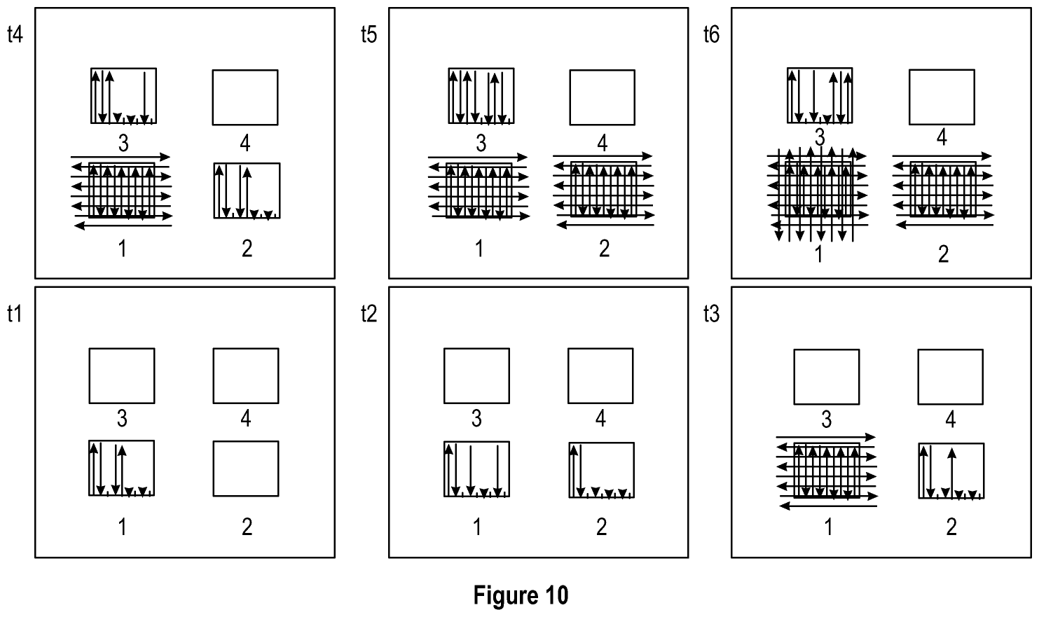

FIG. 10 shows an exemplary scanning strategy for a cross-sectional layer of build comprising four squares (1, 2, 3, and 4). In this example, every point in a square is treated identically to other points in the same square, although the scanning strategy for each square is different. A snapshot of the scanning strategy is illustrated at each square during six time points (t1, t2, t3, t4, t5, and t6). At t1, square 1 is scanned. At t2, square 2 is scanned. At t3, square 1 is rescanned, this time using a scanning pattern that is orthogonal to the initial scan at t1, and also covers an area that is larger than square 1. This may result from a wider beam spot and/or wider spacing between hatches. At t4, square 3 is scanned. At t5, square 2 is rescanned, again using a pattern that is orthogonal to the initial scan at t2, and also covers an area that is larger than square 2. At t6, square 1 is rescanned again, this time in a pattern that is orthogonal to the scan at t3. Subsequent scans at later time points are not shown, but the snapshot illustrates the variation in scanning patterns for each square.

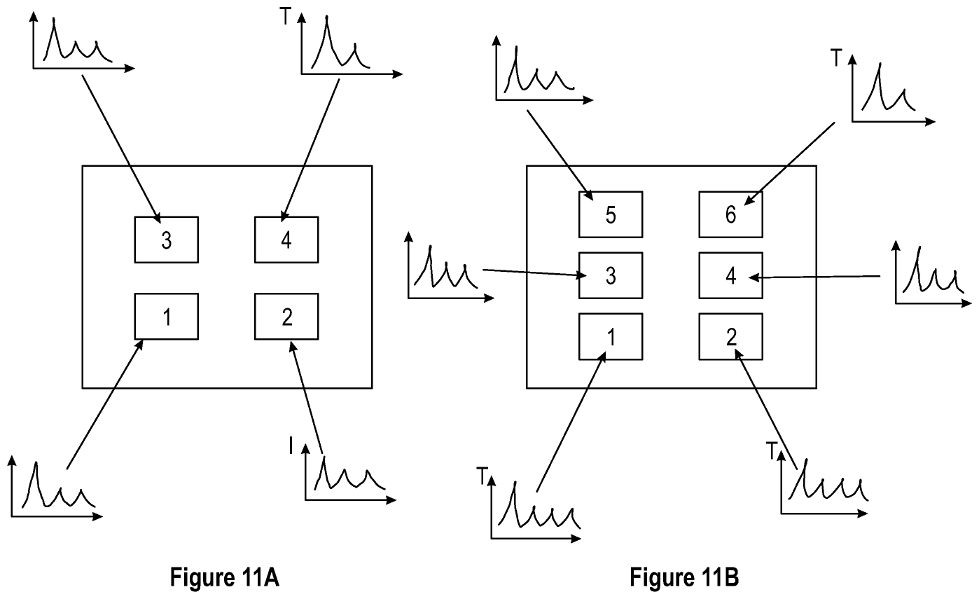

The scanning strategy determined by the computing device may depend on the overall composition of points in the cross-sectional layer of the build. If a build comprises many points to scan, the first point (or first plurality of points) scanned may undergo many more subsequent scans, as compared to a build comprising a fewer points to scan. FIG. 11 illustrates a difference in scanning patterns in two exemplary cross-sectional layers of a build. The cross-sectional layer in FIG. 11A comprises four squares, while cross-sectional layer in FIG. 11B comprises six squares. For simplicity, a thermal cycle from a single point in each square is illustrated. In FIG. 11A, the point in square 1 was scanned 3 times, and the temperature as a function of time was plotted after each scan (as in FIG. 9). Squares 2 and 3 were also scanned 3 times each. Square 4 was scanned twice. In FIG. 11B, squares 1, 2, and 3 were each scanned 4 times each. Squares 4 and 5 were scanned 3 times each, while square 6 was scanned twice. Accordingly, although square 1 in FIG. 11A is similar or even identical to square 1 in FIG. 11B, the scanning strategy for the whole cross-sectional layer accounts for other squares in the cross-sectional layer, and the computing device determines a different scanning pattern.

In some embodiments, the computing device determines the scanning strategy and controls scanning of the build material using the AM apparatus according to the scanning strategy in order to build the cross-sectional layer. The computing device may determine an optimal scanning strategy upfront, so that no further monitoring or corrective action is required during the build. In certain embodiments, the computing device may determine a range of possible scanning strategies, which may be monitored. Monitoring may comprise obtaining thermal profiles during the build, and comparing them to reference thermal profiles, as described in WO 2016/201390, the contents of which are incorporated by reference herein in their entirety. If a deviation from the reference thermal profiles is detected, for example, where the deviation is above a threshold, the computing device may take corrective action, such as changing the scanning strategy or stopping the build. The computing device may store a record of the scanning strategies, both successful and corrected, for future use.

In many laser sintering applications and other powder bed fusion methods for additive manufacturing, the energy density of the scans plays a role in the quality and success of the build. Methods for determining, displaying, and modulating energy density is described in WO2018/064066, the contents of which are incorporated by reference herein in their entirety. A further aspect of the present disclosure is a method for laser sintering, which accounts for energy needed for scanning. A computer-implemented method for laser sintering a cross-sectional layer of build comprises determining, in a computing device, a first level of power needed for scanning a plurality of points on the cross-sectional layer, wherein the first level of power raises the plurality of points to a first temperature; determining, in a computing device, a second level of power for scanning the plurality of points, wherein the second level of power maintains the plurality of points at a second maintenance temperature that is lower than the first temperature; determining a scanning strategy based on the first and second levels of power, wherein the scanning strategy is configured to bring each point in the plurality of points to the first temperature and to maintain each point at or above the second maintenance temperature, starting from a time when the point is first scanned until a time when all points in the cross-sectional layer have been scanned; and controlling scanning of build material using an additive manufacturing apparatus according to the scanning strategy in order to build the cross-sectional layer.

### Exemplary Scanning Strategies

In some embodiments, the computer-implemented method of preparing a scanning strategy for additive manufacturing of a cross-sectional layer of a build comprises obtaining, in a computing device, thermal properties of a build material; deriving from the thermal properties, in the computing device, a range of temperatures suitable for processing the build material for additive manufacturing; obtaining, in the computing device, physical specifications of an additive manufacturing apparatus; determining, in the computing device, a scanning strategy for the cross-sectional layer of the build, wherein the scanning strategy is configured to maintain, for each point of the cross-sectional layer of the build, from the time that the point is first scanned until all points in the cross-sectional layer of the build have been scanned, a maintenance temperature within a range of temperatures suitable for processing the build material, and wherein the scanning strategy is determined at least in part on the physical specifications of the additive manufacturing apparatus; and controlling scanning of the build material using the additive manufacturing apparatus according to the scanning strategy in order to build the cross-sectional layer.

In some embodiments, an exemplary scanning strategy determined by the computing device may comprise one initial scan of a point at a first power, followed by subsequent scans of the point in which at least one of scanning time, laser power, beam spot size, beam spot shape, or number/pattern of scans differs from the initial scan.

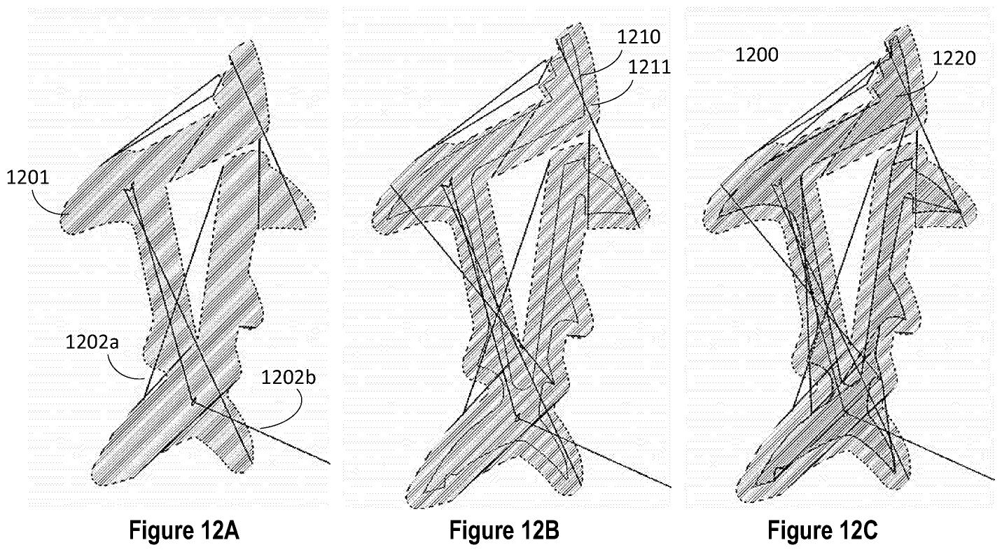

In the scanning strategy, the maintenance temperature may be a set temperature, such as a temperature close to a melting temperature or to any transition temperature of the build material. The maintenance temperature may be a range of temperatures within which the physical, mechanical, and/or thermal properties of most or all of the build material change. In an exemplary scanning strategy, the maintenance temperature may be at or near a first temperature that a point in a cross-sectional build reaches during or after a first scan. FIGS. 12A-12C show a scanning strategy for a cross-sectional layer for an object (1200). In FIG. 12A, a first set of vectors (1201) may be used to scan a first plurality of points. The first plurality of points may comprise all points in the cross-sectional layer of the object. The first plurality of points may comprise a subset of points in the cross-sectional layer of the object, for example, points of the object that fall within a distance (e.g., internal offset) from the boundary of object. The first plurality of points may be surrounded by a second plurality of points in an external offset portion (also “external”) that surrounds or falls outside of the outer boundary (also “border” or “contour” or “edge”)) of the cross section of the object. The outer boundary of the object may be positioned nearby and approximated by the contour-border vectors (1210), which is shown within the offset portion (1211) in FIG. 12B. For example, the contour-border vectors (1210) may be offset approximately 0.01-0.1 mm or may be 0.1-0.5 mm (e.g., 0.3 mm) from the outer boundary. In some embodiments, the offset of the contour-boundary vectors (1210) from the actual, true boundary of the part may be an example of beam compensation, whereby an offset may be determined experimentally to compensate for the laser beam diameter and for material shrinkage.

Collectively, scanning of the first plurality of points (and, if present, the second plurality of points in an offset) may be called preheating scanning. Preheating scanning may be differentiated from a global preheating of all build material, as the global preheating may not be specific to any points on the build, and as the global preheating may have an effect of exposing the build surface to heat lamps. In contrast, preheating scanning may be specific to vectors and points in the build, and may result from scanning with a laser. In some embodiments, global preheating of all build material may be reduced because the preheating scanning may be sufficient to preheat the desired points in the build, prior to subsequent scanning steps. In some cases, reduction of global preheating in the build may reduce thermal degradation of build material. Preheating scanning of the first set of vectors may increase the temperature of the first plurality of points to a first temperature. The first temperature may be the maintenance temperature. For a sample of polyamide 12 (PA12), the maintenance temperature may fall within the range of 170-180° C., for example, 170-175° C.

In FIG. 12B, a second set of vectors may be used to scan a first subset (1210) of the first plurality of points, wherein the first subset comprises points along the contour of the cross section of the object. Scanning of the first subset of points may be called contour scanning. In FIG. 12C, a third set of vectors may be used to scan a second subset (1220) of the first plurality of points, wherein the second subset comprises points in the in-fill (also “hatching” or “volume”) within the contour. Scanning of the second subset of points may be called hatch scanning (also “hatching” or “in-fill scanning”). In general, hatch scanning may be used to scan points that fall within the contour of the cross section of the object, but in the process of hatch scanning, points along the contour may additionally be scanned. For example, if a beam spot size used to scan the end of a hatching vector is wide enough, then it may melt build material on a nearby point on the contour.

The maintenance temperature is reached and maintained by the combination of preheating scanning, contour scanning, and hatch scanning. In some embodiments, the maintenance temperature may be the temperature of the preheating scanning, and may be close to the melting temperature, but may not reach or exceed the melting temperature.

FIG. 12D shows a temperature profile for an exemplary point at the edge (e.g., on the contour) of the cross-sectional layer of an exemplary object. In the temperature profile, the temperature of the point reaches a maintenance temperature during the preheating scanning, and the maintenance temperature is subsequently maintained during the contour scanning and the hatch scanning. The temperature may increase above the maintenance temperature following the contour scanning and hatch scanning, for example, if the contour scanning and the hatch scanning increase the temperature above the melting temperature of the build material. In order to elevate the temperature of the point to the highest temperature, in this case after the hatch scanning, build parameters may be varied. In some embodiments, the laser power may be increased, or laser spot size may be increased at the hatch scanning step, as compared to the preheating scanning and the contour scanning. Alternatively, the preheating scanning step may be performed at a first power level that is lower than a second power at the contour scanning step and also lower than a third power level at the hatch scanning step. The second power of the contour scanning step may be higher than the first power of the preheating scanning step and also higher than the third power of the hatching scanning step. In some embodiments, the resulting temperature of the interior zone scanned by the hatching scanning may be higher, because of cumulative effects of multiple vectors, as contrasted with the energy density at the contour.

In the some embodiments, heat from the scanned interior may transfer to the contour. The accumulated heat from the preheating scanning, contour scanning and the hatch scanning, may be sufficient to increase the temperature at a point on the edge (e.g. on the contour) to the high temperature illustrated in FIG. 12D, even if the hatch scanning was the last scanning step in the sequence.

The scanning strategy may comprise additional preheating scanning steps. For example, a first preheating scanning step may comprise only a first plurality of points that comprises all of the points in the object, while a second preheating scanning step may comprise the first plurality of points and a second plurality of points in an offset around the boundary of the object. A preheating scanning step may comprise a first plurality of points that comprises the boundary of the object, an external offset comprising points outside of the boundary, and an internal offset comprising a selection points inside the boundary.

The scanning strategy may further comprise one or more post-heating scanning steps. A post-heating scanning step may be used to maintain the temperature at one or more points in the cross-sectional layer after the points in the layer have been scanned, for example, to control cooling rates of the one or more points. The scanning strategy may further comprise delays and jumps, such as the jumps (1202a and 1202b) in FIG. 12A. A jump may be a transition in space and time, as a laser finishes scanning a first path (e.g., a first vector) and begins scanning a second path (e.g. a second vector). The first and second vector may be discontinuous from one another, and may have different directions and/or coordinates in space. The laser may jump from the end of the first vector to the beginning of the second vector, and the laser may be turned off during the jump.

In a further exemplary scanning strategy, the maintenance temperature reached at each point in the cross-sectional layer of an object is higher than an onset melting temperature. The onset melting temperature may be the temperature at which the melting of the build material begins. If the build material were held at the onset melting temperature for a long enough period of time (e.g., an indefinite period of time), all of the build material may be expected to melt. However, as the laser sintering process requires coordination of scanning steps and temperature changes, the build material cannot be held at the onset melting temperature for extended periods of time. Accordingly, in some embodiments, the maintenance temperature may be a temperature at which most or all of the crystals in the build material are melted. This temperature may be higher than the onset melting temperature of the build material.

In some cases, the maintenance temperature may be a temperature above the temperature at which the build material shows a memory effect. The memory effect may refer to the tendency of a build material such as a polymer to retain memory for a certain physical state, and to return to that physical state. For example, a polymer may show a memory effect for a crystalline state or shape, e.g., the shape assumed after the melting step with the laser. Crystals in a build material may be any crystalline or semi-crystalline structures of the build material (e.g., a polymer) that have an ordered and/or periodic form such as a lattice. A lattice may comprise a repeated pattern of one or more unit cells arrayed in space. In some cases, the memory effect for a crystalline state or shape may result from or may be enhanced by the presence of residual crystals that act as seeds for forming a crystalline structure. The seed crystals may facilitate the formation of a crystalline structure. In some cases, the memory effect for a crystalline state or shape may result from or may be enhanced when polymer chains of the build material, particularly long polymer chains, form loose connections between each other. The loose connections may stabilize the long polymer chains into a structure that may not be easily separated, even at the melting temperature (e.g., onset melting temperature) of the build material.

Accordingly, if a build material comprises seed crystals and/or long chain polymers that may form connections between each other, the actual temperature at which all of the build material is melted and most or all crystals are eliminated may be increased as compared to build material that does not comprise seed crystals and/or long chain polymers. For example, a sample of used powder like PA12 may comprise more seed crystals and long chain polymers than a sample of virgin powder, and may require a higher temperature to melt crystals and remove crystalline structures or loosely connected polymer chains.

In view of this, a maintenance temperature for a build material in a scanning strategy as described herein may be high enough to eliminate most or all seed crystals and/or most or all connections between long chains in the build material. In certain embodiments, a maintenance temperature or a build material may be experimentally measured, for example, by determining a temperature or range of temperatures at which most or all crystals in a build material are eliminated. The maintenance temperature may be a maximum temperature which may not be exceeded during the scanning strategy. The maintenance temperature may be lower than a degradation temperature. In certain embodiments, a sequence of preheating scanning, contour scanning, and hatch scanning may be used to increase the temperature at one or more points and thereby reach the maintenance temperature in a stepwise manner. The maintenance temperature that is higher than a melting temperature may be a first maintenance temperature. Alternatively, the maintenance temperature may be a second maintenance temperature that is higher than a first maintenance temperature, and may be reached at each point at a later time than the first maintenance temperature is reached.

When samples of build materials differ in processing history, composition, proportion of long to short chains, the maintenance temperature may vary across the samples. For example, a sample of used (or thermally aged) powder may have a higher maintenance temperature than a sample of virgin powder, in part because the used powder may have longer polymer chains and/or more seed crystals than virgin powder. For a sample of used polyamide 12 (PA12), the maintenance temperature at which most or all crystals have been eliminated may fall within the range of 210-230° C., for example, 210-215° C., 215-220° C., 220-225° C., or 225-230° C.

Accordingly, the scanning strategy may comprise a step of increasing the temperature at each point in the cross-sectional layer, until reaching a maintenance temperature that is higher than the melting temperature of the build material. The maintenance temperature may a temperature at which effects on crystallization of seed crystals and long chain polymers in the build material are reduced or eliminated. The temperature may be increased in a stepwise manner, for example, by the combination of a preheating scanning step, a contour scanning step, and a hatch scanning step, in any order.

The maintenance temperature may be maintained in a given point while other points in the cross-sectional layer are scanned. This may be accomplished by slow cooling, so that the temperature at a point does not decrease below the maintenance temperature during subsequent scanning steps. For example, if a point reaches the maintenance temperature, it may then be allowed to cool without further scanning of the point. Or, nearby points may not be scanned, so as to allow the given point to cool. In some embodiments, a maintenance temperature may be maintained by re-scanning a first point in the cross-sectional layer. The maintenance temperature may be maintained by scanning (or re-scanning) a second point or a plurality of points nearby the first point. In certain embodiments, the scanning strategy may be configured to keep a first point at a maintenance temperature until all of the points or a portion of the points in the cross-sectional layer have been scanned.

In certain embodiments, the maintenance temperature may be maintained for only a limited period of time. The period of time may fall within a range of 0.001 second to 1 second, for example, 0.05 sec, 0.1 sec, 0.15 sec, 0.2 sec, 0.3 sec, 0.4 sec, 0.5 sec, 0.6 sec, 0.7 sec, 0.8 sec, 0.9 sec, or 1 sec. In an exemplary scanning strategy, the maintenance temperature may be reached, for example, in a stepwise manner by one or more preceding scanning steps (e.g., a preheating scanning step, a contour scanning step, a hatch scanning step, and/or other scanning step), and no further scanning steps are required after reaching the maintenance temperature.

In certain embodiments, the scanning strategy may comprise a series of scanning steps configured to control temperatures at one or more points on the cross-sectional layer. The temperature may be maintained during a build at all of the points on the cross-section of the object, or at a subset of points. For example, the temperature at select points in critical regions of an object may be maintained while the other points in the cross-section of the object are scanned. The points along the boundary of the cross-sectional object may be critical, since the boundaries of the cross sectional layers together form the surface of the final 3D object. In some embodiments, the points along the boundary are maintained at a maintenance temperature for the duration of the time that the cross section of the object is scanned. Points along the boundary may be critical for a high quality surface finish of the final object, and/or may be critical because these points may lose more heat than a point in the center of the object.

The scanning strategy may comprise a first scan of points, for example, by scanning a vector comprising a plurality of points, or by scanning a set of vectors, followed by at least a second scanning of some or all of the points, vectors, or set of vectors. Points in the build may be grouped into a plurality of points according to similarity of vectors (e.g., hatches, borders, fill, or edges), or according to any data blocks in which similar points may be generalized.

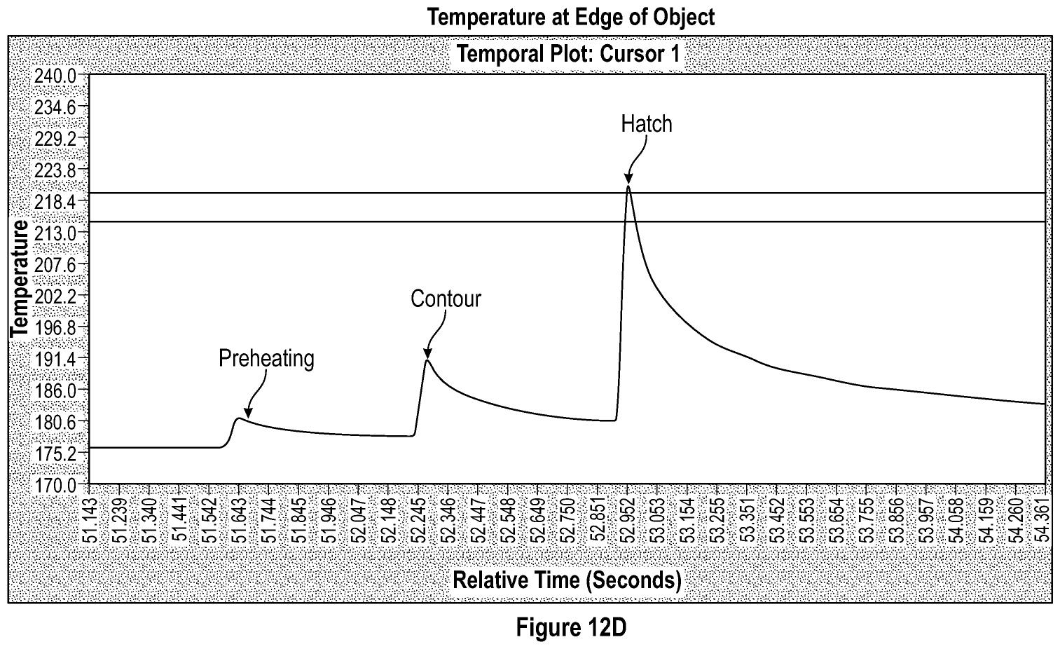

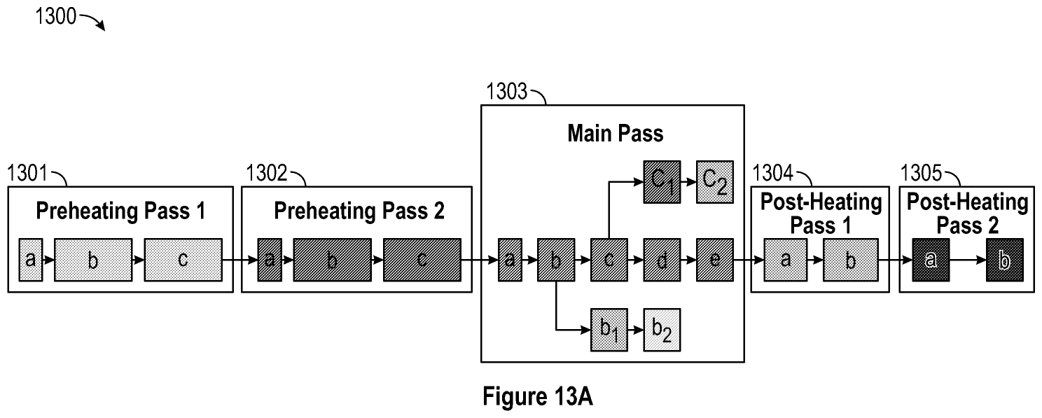

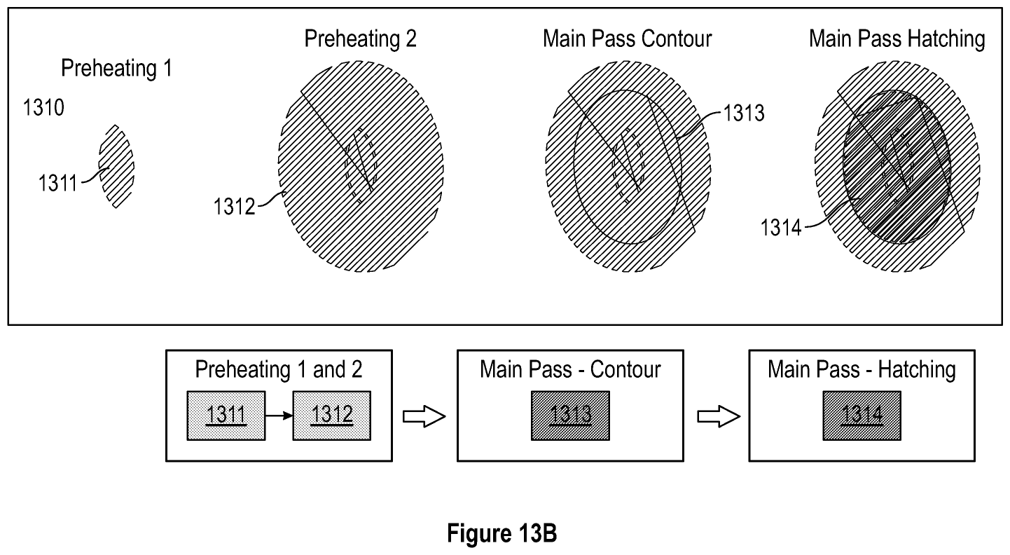

FIG. 13A shows an exemplary scanning strategy (1300) in which sets of vectors are represented as blocks (also “data blocks”). A block may comprise a plurality of points grouped according to similarity (e.g., hatch vectors, borders, fill, or edges), or according to measure by which similar points or vectors may be generalized. Each set of vectors corresponds to points in the cross-sectional layer, and each block may be scanned in an order. The scanning strategy illustrates how blocks may be configured in order to coordinate the timing for scanning the vectors and thus, for scanning the points in the cross-sectional layer.

A first step of the scanning strategy (1300) may be a first preheating scanning step (preheating pass 1 (1301)), in which 3 blocks (marked a, b, and c) may each be scanned in sequence. In a second step, preheating pass 2 (1302), 3 blocks (a, b, and c) may each be scanned in sequence. The blocks in preheating pass 2 may be the same blocks as in preheating pass 1, or may be different blocks. For example, preheating pass 1 may comprise vectors covering a first portion of the cross section of the object, while preheating pass 2 may comprise vectors covering a second portion of the cross section of the object that is not the same as the first portion. Preheating pass 1 and preheating pass 2 may comprise the scanning of points that are both external to the object (e.g., points located in the offset that is outside of the boundary of the object), as well as points along the boundary of the object and points that are internal to the object. One or both of preheating pass 1 and preheating pass 2 may comprise scanning of points along the boundary of the object and/or points that are internal to the object, but not points that are external to the object.

In a next step, a main pass (1303) of blocks may be scanned. Here, a set of 5 blocks, marked a, b, c, d, and e, may be scanned in sequence, but any number of blocks (e.g., 1, 2, 3, 4, 5, 6, 7, 8, 9, 10 or more) may be selected and scanned in sequence. Blocks may comprise vectors having characteristics that facilitate the grouping of the vectors into a block. In certain embodiments, blocks may comprise vectors that are close in spatial location to one another, or may comprise vectors that are oriented in the same direction. A block may comprise only contour vectors or only hatch vectors. A block of vectors may comprise vectors that are all processed according to the same processing parameters, e.g., the same laser power for all vectors in the block. In some embodiments, blocks may be selected according to the time required to scan the vectors. For example, if the scanning strategy was configured to fit 1 second of scanning time per block, but the object comprised a plurality of vectors whose scanning time required 5 seconds in total, then the plurality of vectors may be divided into 5 blocks, each of which block takes 1 second to scan. Each block in a scanning strategy may be ordered to fit into time allotted for scanning, and may be ordered to optimize the scanning.

The 5 blocks may collectively comprise vectors comprising points along the boundary of the object and/or internal to the object. Blocks may be re-scanned. Block b may be re-scanned twice (shown as block b₁ and block b₂). Block c may be also re-scanned twice (shown as block c₁ and block c₂). A re-scan of block b (e.g., b₁ and/or b2) may be a scan that is identical to block b. Alternatively, one or both of block b₁ and block b2 may differ from block b in the set of vectors, the direction of vectors, the spacing between vectors, as well as laser parameters such as laser power, speed, beam spot size, beam shape, and more. Either or both of block c₁ and block c₂ may be a scan that is identical to block c, or may differ from block c.

In some embodiments, a first post-heating pass (1304) and a second post-heating pass (1305) of blocks may be scanned. In this example, each of the first post-heating pass (1304) and the second post-heating pass (1305) comprise 2 blocks.

The blocks may be modular, so that the scanning and re-scanning and ordering of scanning may be flexible. For example, the temperature of a point or plurality of points in the build may be improved by timing the order of scanning. For example, preheating pass 1 (1301) and 2 (1302) may be configured to heat the build material to a first temperature, at points both internal and external to the object. Then, the main pass (1303) may be configured to heat points of the build material to a second temperature, for example, to the melting temperature of the build material or to a temperature that is greater than the melting temperature. This may be accomplished by scanning blocks a, b, c, d, and e in the main pass (1303). For some of the points, e.g., points in block b and in block c, it may be necessary to re-scan in order to achieve or maintain a temperature. Accordingly, block b may be re-scanned twice (block b₁ and block b₂), and block c may be re-scanned twice (block c₁ and block c₂). In some embodiments, scanning and re-scanning may be ordered, so that blocks b₁ and b₂ may be scanned after block b and block c, but before block c₁ and c₂. Alternatively, blocks b₁ and b₂ may be scanned after block b but before blocks c, d, e, c₁, and c₂. Other sequences of scanning the blocks may be possible. An advantage of the scanning strategy is the flexibility with which blocks may be ordered, scanned, and re-scanned in order to control the temperature of the points in a block and in the object at any given time (e.g. a time-temperature curve or profile). In general, a scanning strategy may incorporate delay periods in between scanning of blocks, wherein the delay periods may be configured to space the scanning of blocks in time.

FIG. 13B illustrates how the vectors in a region may be scanned in blocks. In object 1310, region 1311 is scanned in a first preheating scanning pass comprising scanning of a single block. Subsequently, region 1312 is scanned in a second preheating scanning pass comprising scanning of a block. In this example, regions 1311 and 1312 are not overlapping. Next, region 1313 is scanned. This region is at or near the contour of the cross section of the object, and is scanned according to a main pass contour scanning of a single block. Finally, region 1314, which is the in-fill region interior to the region 1313, is scanned according to a second main pass scanning (e.g., hatching scanning) of a single block. In this example, each region is scanned in one block. In some embodiments, a region may be divided into two or more regions, such as non-overlapping regions 1311 and 1312. A region may be divided into overlapping or adjacent regions, such as the contour region 1313 and the in-fill region 1314. Regions, whether overlapping, adjacent, or non-overlapping, may be scanned as a single block of vectors or as more than one block of vectors.

A cross-sectional layer of a build may comprise cross-sections of one or more parts. For example, a plurality of cross-sectional layers of the build may together form one or more 3D parts. In some embodiments, one or more points in the cross-sectional layer of the build may not correspond to a part. In certain embodiments, all scanning of a cross-section of one part may be completed before proceeding to another part in the layer. A cross-sectional layer of a build may refer to a cross section of one part, or may refer to more than one part in a layer. A first scanning strategy may be configured for scanning a first portion of a cross-sectional layer that comprises a cross section of a first part, while a second scanning strategy may be configured for scanning a second portion of a cross-sectional layer that comprises a cross section of a second part. The first and second parts in a cross-sectional layer may be separate objects or may be two regions of the same object.

### Zoning

A further aspect of the present disclosure relates to a scanning strategy comprising a plurality of scanning strategies for zones in cross section of an object. In some embodiments, a cross sectional of an object or a portion of a cross section may be divided in zones and/or sub-zones. Zones may be uniform in size and shape, or one or more zones may have a different size and shape from other zones. Zones may be continuous with (e.g., connected to) one another, or zones may be non-continuous (e.g., not connected) with one another. A first scanning strategy comprising one or more vectors and/or scanning parameters (e.g., laser parameters such as laser speed, laser power, beam spot size, beam spot shape, etc.) and used to scan a first zone may be different from a second scanning strategy used to scan a second zone, especially if the zones differ in size and/or shape. An object or portion of an object that does not contact any other object or portion of an object in the cross section of the object may be considered to be an island in the cross section of the object. A cross section may have more than one island, and a first island may be completely scanned according to a first scanning strategy before other islands in the cross-sectional layer are scanned according to other scanning strategies.

In some embodiments, the scanning strategies for each island may be configured to control the temperature at one or more points in the island. For example, two or more blocks of scanning may be used to raise, in a stepwise manner, the temperature at one or more points in the island. The temperature of the points in the island may be a maintenance temperature.

A variety of different scanning strategies may be selected for an island. In a core-hull scanning strategy, an inner region (e.g., core) may be scanned according to a first strategy, while a surrounding region (e.g., hull) may be scanned according to a second strategy. For example, a core region may be scanned every 3 layers, but with a larger beam spot under higher power, so that the build material of all 3 layers is scanned at once. The hull region, meanwhile, which is the region of the object between the core and the boundary of the object, may be scanned at each layer. In some embodiments, the core may be any region in the interior of the object and may comprise the bulk of the object, while the hull is any region close to edge of the part, e.g., surrounding the core and including the boundary. A core may be scanned at a higher laser power, while a hull may be scanned at a lower laser power.

In another scanning strategy, an island may be divided into an interior zone and a contour zone. A contour zone may be, like a hull, a region surrounding an interior region, such as a contour of the object plus an offset, while the interior zone may be any area that is interior to the contour zone. In some embodiments, a contour zone may be the contour (e.g., boundary) of the cross section of the object. An interior zone may be any part of the cross section that is interior to the contour. In some embodiments, there may be a very slight offset (e.g., less than 1 mm, or less than 0.5 mm) between the interior zone and the contour zone. Due to the beam spot size and shape, the slight offset between the interior zone and the contour zone may be sufficiently scanned when the laser scans overlap during scanning of the contour zone and the interior zone. The contour zone may be scanned according to a first scanning strategy in which, e.g., parameters such as laser power, laser scanning speed, laser beam spot size (e.g., diameter) and/or shape, spacing between vectors, and patterns of jumps and delays between the vectors, have been optimized to control temperature of points in the contour of the island. The interior zone of the island may be scanned according to a second scanning strategy that may be different from the first scanning strategy. The scanning strategy may further comprise a preheating scanning strategy which may be different from the first scanning strategy and/or the second strategy. The preheating scanning strategy may comprise scanning points that are exterior to the island (e.g., an offset). In some embodiments, the scanning strategy further comprises a postheating scanning step.

For example, a scanning strategy for an island may comprise preheating scanning, wherein a first plurality of points in the island and a second plurality of points exterior to the island are scanned; contour scanning, wherein a first subset of the first plurality of points are scanned, the first subset corresponding to a contour (e.g., boundary) around the island; and hatch scanning, wherein a second subset of the first plurality of points are scanned, the second subset corresponding to points of the island inside the boundary. Each of the preheating scanning, contour scanning, and hatch scanning steps may comprise a set of vectors and scanning parameters that differ from other steps. For example, the preheating scanning step scans vectors comprising both the first plurality and the second plurality of points, whereas the contour scanning step scans vectors only along the contour of the island, and the hatch scanning step scans vectors only inside the boundary of the island. Moreover, if the desired temperature to be reached after the preheating scanning step is lower than the temperature to be reached after the contour scanning step and the hatch scanning step (see, e.g., FIG. 12D), then the scanning parameters in the preheating scanning step may be varied as compared to the contour and hatch scanning steps. For example, a lower laser power and/or lower laser speed may be used for the preheating scanning step. A scanning strategy may further comprise a post-heating scanning step. The post-heating scanning step may be used to maintain the temperature at one or more points in the cross-sectional layer, for example, to control cooling rates of the one or more points.

In some embodiments, islands in the cross sectional layer may be identified, and each island may be scanned according to its own scanning strategy. In addition, islands may be further divided into a plurality of zones, wherein each zone has a scanning strategy that may differ from the scanning strategy of at least one other zone. In one example, energy density of vectors in a cross section of the object and/or thermal measurements of the cross section of the object during or after the build may be evaluated. If either or both of the energy density or heat distribution across the cross section of the object is heterogeneous and uneven, then the scanning strategy may be adjusted so that each region of heterogeneity may be a zone. A hot spot having a higher temperature and/or greater energy density may become a first zone in which a lower laser scanning speed or lower laser power may be used. A cold spot having a lower temperature and/or lower energy density may become a second zone in which a higher laser scanning speed or higher laser power may be used.

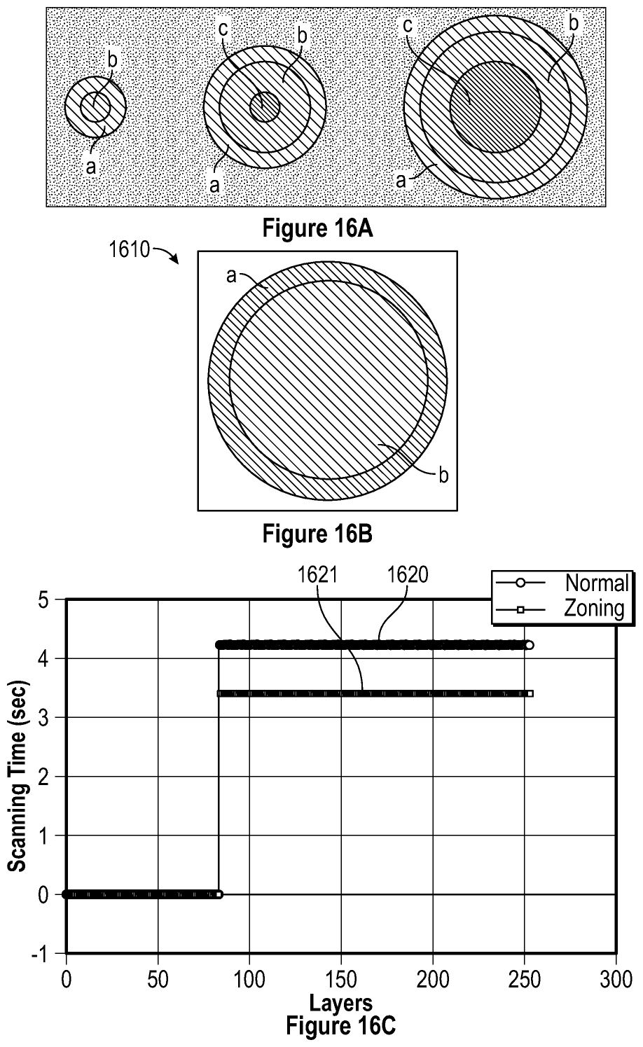

FIGS. 16A-16C illustrate zoning of exemplary cross sections of objects. In FIG. 16A, objects 1601, 1602, and 1603 have been divided into zones. Object 1601 has been divided into 2 zones (a and b), while each of object 1602 and object 1603 have been divided into 3 zones (a, b, and c). The zones may be determined, for example, by starting at the boundary of the object and moving internal to the object (e.g., creating an internal offset). As illustrated by object 1602 and object 1603, each of which have been divided into 3 zones, the size of the zones may be varied. Zone c in object 1603 is a larger proportion of the object than is zone c in object 1602. In some embodiments, the distribution of heat and/or the energy density in an object may be used to determine the zones. For example, in an object such as 1603, the comparatively large center may retain heat, while the outer edge of the object dissipates heat. Accordingly, the center may become zone c, which may be scanned according to a scanning strategy where less heat and less energy density is applied. The edge may become zone a, which may be scanned with more heat and more energy density than zone c. An intermediate zone b may be scanned with heat and energy density at a level that is in between zone a and zone c. In certain embodiments, laser power, laser scanning speed, beam spot size and beam shape may be varied during scanning of each zone, to account for differences in energy density across each zone. As a result of zoning and the differences in build parameters, the overall temperature and/or energy density across the zones of the object may be similar to one another.

FIG. 16B shows an object 1610 that is zoned into a core region (b) and a hull region (a), where the beam spot size is varied across the two regions. In this example, the core region (b) may be scanned with a laser beam diameter that is different than the laser beam diameter used to scan the hull region (a). For example, the core region (b) may be scanned with a laser diameter of 1.0 mm, while the hull region (a) may be scanned with a laser diameter of 0.6 mm. One result of this approach is increased speed (e.g, reduced scanning time) when building the object. FIG. 16C shows a plot of the scanning time as a function of the layers scanned. The scanning time using the zoning approach in which the core region is scanned with a larger beam diameter than the hull region (1621) is decreased relative to scanning without varying the beam diameter (1620), after approximately 80 layers of the object have been scanned.

### Overheating

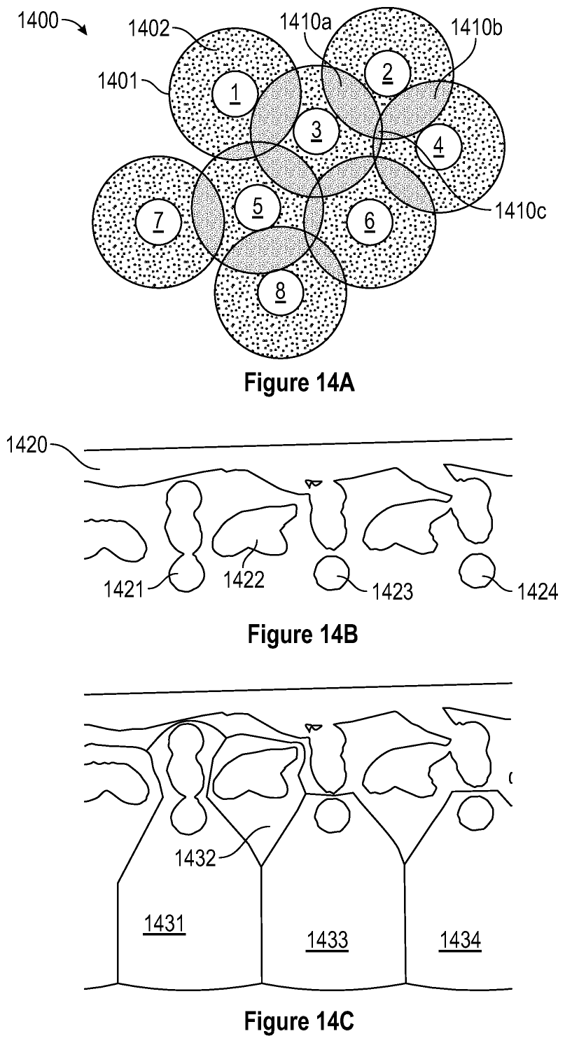

Preheating and/or post-heating scanning may comprise scanning of points or vectors in an offset region, such as an external offset surrounding the boundary of an island. A problem may arise when there is more than one island in a cross-sectional layer of a build and the islands are positioned near to one another. In this case, the offsets that are external to each island may overlap with one another, leading to overheating at the overlapping areas that get scanned more than once. FIG. 14A shows the overlapping areas in an exemplary cross-sectional layer of a build (1400) comprising a plurality of islands 1401 (numbered 1-8), each having an offset (1402). Regions of overlap 1410a, 1410b, and 1410c are indicated, with region 1410c likely to show the greatest effects of overheating, because it would be scanned and re-scanned when the offset of each of islands 2, 3, and 4 are scanned in preheating scanning steps. Local overheating at overlap regions may affect the quality of the objects in the build. For example, overheating may result in local regions where the temperature is too high, so that islands beside the local regions cannot cool evenly after melting or sintering. In some cases, when the temperature in the overlap regions reaches the melting temperature of the build material, the overlap regions may melt and sinter and thereby create bridges of sintered build material in between the islands.

To address the local overheating at overlapping offsets, a computing device may identify islands that are close together and likely to have overlapping offsets. An exemplary offset may be set at less than 0.5 mm, 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, or more than 6.5 mm. Before a build begins, the computing device may check the position of two or more islands and identify when the islands are close enough to have overlapping offsets. The computing device may then reconfigure the build to space the islands further apart, so that the overlap between the islands is reduced or eliminated. In some embodiments, overlap of 2 offset regions may be permitted, whereas overlap of 3 or more offset regions would not be permitted, and at least one of the islands would have to be replaced in order to eliminate the overlap.

In certain embodiments, the computing device generates a new scanning strategy for the overlap regions, without repositioning the islands. The scanning strategy comprises setting a geometric-shaped region (e.g., the region may be a polygonal region or may be a circle or an ellipse) for each island that has neighboring islands with neighboring or overlapping offset regions. FIG. 14B shows a cross section of an object, wherein the cross section comprises a plurality of islands (1421, 1422, 1423, and 1424), positioned close to one another. If external offsets were to be generated as in FIG. 14A, the offsets of the islands would overlap. FIG. 14C shows geometric-shaped regions (polygonal regions 1431, 1432, 1433, and 1434) set around each of islands 1421, 1422, 1423, and 1423 (not marked). The polygonal region may comprise a polygon wherein most or all points in the polygon are closer to the island than to any other island. This division of space may be described as a modified Voronoi diagram, where space is partitioned based on minimal distance to a given point. Accordingly, the scanning strategy may be configured to detect the boundaries of each geometric-shaped region, and may limit the scanning of the offsets to spaces within the boundaries of the geometric-shaped region. Because each island has its own geometric-shaped boundary, the offset regions may no longer overlap.

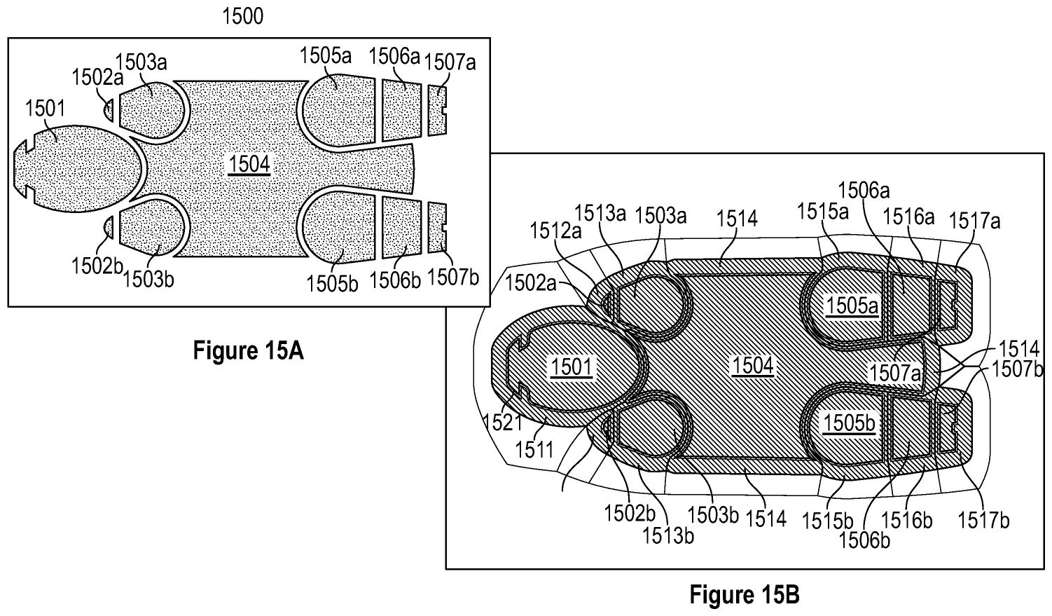

FIGS. 15A-15B illustrate the vectors scanned in islands and in offset regions bounded by geometric-shaped regions. FIG. 15A shows a cross section of an object comprising 12 islands, numbered 1501, 1502a, 1502b, 1503a, 1503b, 1504, 1505a, 1505b, 1506a, 1506b, 1507a, and 1507b. FIG. 15B shows the offset regions surrounding each of the islands (geometric-shaped regions 1511, 1512a, 1512b, 1513a, 1513b, 1514, 1515a, 1515b, 1516a, 1516b, 1517a, and 1517b). Each island also has a contour (e.g., contour 1521 around island 1501 is marked). In FIG. 15B, none of the offset regions overlap. Sets of vectors in each island and each offset region appear as hatched lines. A scanning strategy for scanning the cross section of the object 1500 comprises a plurality of scanning strategies for each offset region, each contour, and each island in-fill area. The hatch lines in offset region 1511 are spaced differently than those in island 1501. In addition, at least one or more of laser power, laser speed, beam spot size, and beam shape may be different when offset region 1511 is scanned, as compared to island 1501.

### Multiple Lasers and Arrays

For scanning, one or more lasers may be used to scan the plurality of points in the cross section of the object. In some embodiments, a single laser may be used for all scanning steps. The single laser may be configured to have more than one beam spot size and/or shape. Scanning steps may be sequential, such that a vector or a block may undergo preheating scanning before a subsequent scanning step such as a contour scanning step and a hatch scanning step. In some embodiments, the laser may scan one or more points with a first beam spot size, and may immediately scan the same one or more points with a second beam spot size.

Two or more lasers may be used for the scanning steps. Each laser may be configured to scan its own field, or each laser may be configured to scan the same field. Accordingly, a first laser may be configured to scan a first portion of a cross section of an object, for example, for a preheating scan of a first plurality of points in the object plus a second plurality of points in an external offset region. A second laser may be configured to scan a first subset of points in the first plurality of points, wherein the first subset corresponds to points along the boundary of the object. The first laser may be configured to scan a second subset of points in the first plurality of points, wherein the second subset corresponds to points inside the boundary of the object. Alternatively, a third laser may be configured to scan the second subset of points. The use of two or more lasers to scan different regions such as offset or islands may enable faster scanning and/or may facilitate timing of scanning for ordered blocks.

In certain embodiments, two or more lasers may be configured to scan and re-scan the same point in an object, the same vector, the same block, the same region, and/or the same type of scan in a scanning strategy. For example, one laser may be used to preheat a first set of blocks in a first preheating pass, while the second laser may be used to preheat the same first set of blocks in a second preheating pass. Or, the two or more lasers may be configured to scan different points, vectors, blocks, regions, and scans in a sequential manner. For example, a first laser may be used to preheat a first set of blocks in a preheating pass, while a second laser may be used to scan a second set of blocks in a main pass.

Arrays of lasers may be used for scanning steps in the scanning strategies described herein. In one exemplary system, thousands of lasers may be configured to project onto a cross section of an object or a portion of a cross section. The lasers may project in a pattern corresponding to the cross section of the object or portion of the object, and may be coordinated to project the laser in an ordered sequence. In some embodiments, at least part of the array of lasers may be used for preheating scanning, contour scanning, hatch scanning, and optionally, for post-heating scanning. Power of the lasers may be modulated in order to provide less power during preheating or post-heating scanning, as compared to contour or hatch scanning. Moreover, in some embodiments, a thermal camera may be configured to determine the temperature of the scanned cross section, and provide feedback to modulate laser parameters. For example, if the thermal camera indicated that the temperature was lower than expected, more lasers could be projected, or the laser speed or laser power could be increased.

In another exemplary system, a multi-beam fiber optic laser array may be used to shape a time-temperature curve during a build. For example, the number of passes over a region on the build, power of one or more lasers, and/or scanning speed of the array may be varied to control the temperature at a point or vector.

In AM systems that use ink or binding agents to modify the heat absorption of a build material, the time-temperature curve may be modulated by varying intensity of the binding agent, varying the quantity of binding agent or detailing agent, changing the power of heat lamps (e.g., IR lamps) used to fuse build material after binding agent has been applied, and/or controlling the number of passes that the lamps make over the build material or the timing of passes.

In certain embodiments, two laser beams from a single scanner may be overlaid on each other. Preheating may be accomplished in one scan by the synchronous action of the two beams.

### Recycled Powder as a Build Material

In certain aspects, a build material may be any polymer powder, for example, the polymer powders disclosed herein. The build material may be PA12. In some embodiments, the build material comprises recycled powder, or comprise a mix of recycled and virgin powder. Recycled powder, whether alone or in a mixture, may be difficult to process, especially when process parameters are tested using a subjective approach. In one aspect of the present disclosure, recycled powder may be effectively processed using a scanning strategy which maintains the recycled powder at a minimum maintenance temperature. For recycled powder, the minimum maintenance temperature may be the crystallization temperature of the recycled powder.

In a recent study, the use of multiple scans at various preselected energies was reported to improve mechanical properties and dimensional accuracy of the resulting part (U.S. Pat. No. 7,569,174, incorporated herein in by reference its entirety). The mechanism for the improved properties was attributed to molten material flowing together in discreet incremental steps, which was possible when scans were modulated so as to keep the material heated to slightly above its melting point. Using multiple scans at low temperature, the heat applied to powder could be limited, and the amount of melting that each particle undergoes could be limited. Thus, the amount of time that powder spends in a low viscosity state could be reduced. Viscous material could flow in a controlled manner and cool before any undesirable distortion of the part occurred, for example, because of over-melting and consequent growth. The multiple scans were also reported to lead to increased density of the part.

While multiple scans as described in U.S. Pat. No. 7,569,174 may be suitable for processing virgin powder, the methods may not address issues with recycled powder. In some cases, it is believed that recycled powder, particularly recycled PA12, may comprise a higher proportion of long polymer chains than virgin powder, which makes recycled powder more viscous in the molten state than virgin powder, while at the same time the recycled powder is also more crystalline. Many polymers show an inverse relationship between crystallinity and viscosity, both of which depend on polymer chain length. Polymers with short chains are often considered “crystalline” or “semi crystalline” and have a high degree of crystallinity (i.e., a high percentage of the volume of material is crystalline) and a low viscosity. Conversely, polymers with long chains are often considered “amorphous” and have a low crystallinity (i.e., a low percentage of the volume of material is crystalline) and a high viscosity. Recycled powder is both highly crystalline and highly viscous.

In recycled powder, the increase in long polymer chains may result from thermal aging, for example, following exposure to elevated temperatures during preheating of build material and/or as heat dissipated from sintered powder nearby. In order to process recycled powder, it may be important to account for both high viscosity that may lead to low flow and slow densification during sintering, as well as high crystallinity that may lead to slow or incomplete melting. The inventors have further observed the phenomenon, not previously reported in the literature, that using highly crystalline samples of recycled powder, may predispose the recycled powder to curling, warpage, and surface defects. A common problem when using recycled powder is a surface defect called an orange peel effect, characterized by pitting and a rough surface texture. The orange peel effect was previously thought to result only from the high viscosity of recycled powder. A link between crystallinity and surface defects may have been obscured by studies suggesting that recycled powder has a lower T_{c} than virgin powder, suggesting that recycled powder may not crystallize as readily as virgin powder. In these studies, T_{c} was measured in DSC experiments where samples are heated and cooled slowly, which would have given the crystals time to melt thoroughly. However, under typical laser sintering conditions, in which samples are heated quickly, it is likely that recycled powder does not melt entirely and leaves seed crystals in the melted powder (European Polymer Journal 92 (2017) 250-262). In recycled powder, the number of seed crystals may be higher than in virgin powder. These seeds crystals may promote early recrystallization of the part, leading to curling and the orange peel effect. The effect of the seed crystals may be compounded by high viscosity, for example, if seed crystals have limited freedom to move or melt in the viscous material.

Accordingly, the present methods provide for a computing device that determines a scanning strategy suitable for processing recycled powder, wherein the scanning strategy addresses the dual problems of high crystallization and high viscosity. Turning first to the high crystallization, the scanning strategy may be configured to melt the recycled powder and reduce or eliminate the seed crystals. In some embodiments, the scanning strategy may promote even melting of the recycled powder in order to eliminate as many crystals as possible, in combination with scans that maintain the recycled powder at a maintenance temperature above the crystallization temperature, in order to prevent recrystallization. This scanning strategy may be applied to each point of the cross-sectional layer of the build, so as to avoid cooling and crystallization from occurring in a first portion of the cross-sectional layer that is scanned earlier than a later portion of the cross-sectional layer. At the same time, a scanning strategy that is configured to promote even melting and maintenance above the crystallization temperature, for example, with an initial scan followed by additional scans, may also raise the average temperature across all points in the cross-sectional layer, thereby lowering the viscosity. The computing device may determine a scanning strategy that is configured to achieve both goals.

Thus, a scanning strategy for recycled powder may comprise one or more initial scans to melt the recycled powder, and hold it at a temperature slightly above the melting temperature for a long interval. Subsequently, one or more scans may be used to maintain the temperature at each point of the cross-sectional layer at a maintenance temperature, until all points in the cross-sectional layer have been scanned. The maintenance temperature may be within a range comprising an upper limit that is around or above the melting temperature and a lower limit that is above the crystallization temperature.

In some embodiments, a computer-implemented method of preparing a scanning strategy for additive manufacture of a cross-sectional layer of a build from a build material comprising recycled powder comprises obtaining, in a computing device, thermal properties of a build material comprising recycled powder; deriving from the thermal properties, in the computing device, a range of temperatures suitable for processing the build material for additive manufacturing; obtaining, in the computing device, physical specifications of an additive manufacturing apparatus; determining, in the computing device, a scanning strategy for the cross-sectional layer of the build, wherein the scanning strategy is configured to maintain, for each point of the cross-sectional layer of the build, from the time that the point is first scanned until all points in the cross-sectional layer of the build have been scanned, a maintenance temperature within the range of temperatures suitable for processing the build material comprising recycled powder, and wherein the scanning strategy is determined at least in part based on the physical specifications of the additive manufacturing apparatus, and controlling scanning of the build material using the additive manufacturing apparatus according to the scanning strategy in order to build the cross-sectional layer.

In some embodiments, the maintenance temperature may be a temperature that is below the melting temperature of the recycled powder. For a sample of recycled polyamide 12 (PA12), the maintenance temperature may fall within the range of 170-180° C., for example, 170-175° C. The maintenance temperature may be reached by a preheating scanning step.

In certain embodiments, the maintenance temperature may be a temperature that is above the melting temperature of the recycled powder. For a sample of used polyamide 12 (PA12), the maintenance temperature may fall within the range of 210-230° C., for example, 210-215° C., 215-220° C., 220-225° C., or 225-230° C. Such a maintenance temperature may be reached, for example, by using a scanning strategy comprising a preheating scanning step, a contour scanning step, and a hatch scanning step, in order to raise the temperature at a point in a stepwise manner.

An exemplary scanning strategy for recycled powder may be configured to maintain, for each point of the cross-sectional layer of the build, from the time that the point is first scanned until all points in the cross-sectional layer of the build have been scanned, a first maintenance temperature within the range of temperatures suitable for processing the recycled powder, wherein the first maintenance temperature is near to but below the melting temperature of the recycled powder. The scanning strategy may be further configured to increase the temperature of each point in the cross-sectional layer to a second maintenance temperature that is above the melting temperature but below the degradation temperature of the recycled powder. The second maintenance temperature may be high enough to eliminate most or all seed crystals and/or crystals formed in the build material. The scanning strategy may be configured so that each point in the cross sectional layer reaches the second maintenance temperature. In some embodiments, islands in the cross sectional layer may be identified, and each island may be scanned according to its own scanning strategy. In addition, islands may be further divided into a plurality of zones, wherein each zone has a scanning strategy that may differ from the scanning strategy of at least one other zone.

What is claimed is:

1. A computer-implemented method of preparing a scanning strategy for additive manufacture of a cross-sectional layer of a build, comprising:
obtaining, in a computing device, thermal properties of a build material;
deriving from the thermal properties, in the computing device, a range of temperatures suitable for processing the build material for additive manufacturing;
obtaining, in the computing device, physical specifications of an additive manufacturing apparatus;
determining, in the computing device, a scanning strategy for the cross-sectional layer of the build,
wherein the scanning strategy is configured to maintain, for each point of the cross-sectional layer of the build, from the time that the point is first scanned until all points in the cross-sectional layer of the build have been scanned, a maintenance temperature within the range of temperatures suitable for processing the build material, and
wherein the scanning strategy is determined at least in part based on the physical specifications of the additive manufacturing apparatus, and
controlling scanning of the build material using the additive manufacturing apparatus according to the scanning strategy in order to build the cross-sectional layer.

2. The method of claim 1, wherein the thermal properties of the build material comprise temperatures at which the build material transitions to different states.

3. The method of claim 1, wherein the thermal properties of the build material comprise rates at which the build material heats or cools.

4. The method of claim 1, wherein the maintenance temperature is within a range comprising an upper limit that is below a melting temperature and a lower limit that is above a crystallization temperature at which the build material crystallizes after melting.

5. The method of claim 1, wherein the scanning strategy further comprises a step wherein temperature at each point of the build is increased to a second maintenance temperature.

6. The method of claim 5, wherein the second maintenance temperature is within a range comprising an upper limit that is around a degradation temperature at which the build material degrades and a lower limit that is above the melting temperature of the build material.

7. The method of claim 1, wherein the physical specifications of the additive manufacturing apparatus comprise at least one of number of lasers, laser beam shape, laser beam size, minimum laser power, maximum laser power, scanner delays, and maximum scanning speed.

8. The method of claim 1, wherein the scanning strategy comprises instructions regarding at least one of a selected laser, a laser power, a laser shape, a laser beam spot size, a scan time, and a number of scans for scanning points on the cross-sectional layer of the build.

9. The method of claim 1, wherein the scanning strategy comprises at least one scan of a point to melt the build material.

10. The method of claim 1, wherein the scanning strategy comprises a first scanning strategy for a first point or a first plurality of points and a second scanning strategy for second point or a second plurality of points.

11. The method of claim 10, wherein the first scanning strategy differs from the second scanning strategy.

12. The method of claim 10, wherein the first plurality of points differs from the second plurality of points in at least one of spatial location and temporal order.

13. The method of claim 10, wherein the first plurality of points is a first subset of points and the second plurality of points is a second subset of points, wherein the first subset and the second subset together form points on the cross sectional layer of the build.

14. The method of claim 10, wherein the first scanning strategy is a contour scanning strategy and the second scanning strategy is a hatching scanning strategy.

15. The method of claim 10, wherein the scanning strategy further comprises a preheating scanning step, prior to the first scanning strategy and the second scanning strategy.

16. The method of claim 15, wherein the preheating scanning step comprises scanning a plurality of points that are external to and offset from the boundary of an object in the cross-sectional layer.

17. The method of claim 10, wherein the scanning strategy further comprises at least a third scanning strategy, wherein the third scanning strategy differs from the first scanning strategy and the second scanning strategy.

18. The method of claim 1, wherein the cross-sectional layer of the build comprises cross-sections of one or more parts.

19. The method of claim 1, further comprising a plurality of cross-sectional layers of the build, which together form one or more 3D parts.

20. The method of claim 1, wherein one or more points in the cross-sectional layer of the build do not correspond to a part.

21. The method of claim 1, wherein the build material comprises recycled powder or a mix of recycled and virgin powder.

22. The method of claim 1, further comprising monitoring the scanning of the build material according to the scanning strategy.

23. A computer-implemented method for laser sintering a cross-sectional layer of build, comprising:
determining, in a computing device, a first level of power needed for scanning a plurality of points on the cross-sectional layer, wherein the first level of power raises the plurality of points to a first temperature;
determining, in a computing device, a second level of power for scanning the plurality of points, wherein the second level of power maintains the plurality of points at a second maintenance temperature that is lower than the first temperature;
determining a scanning strategy based on the first and second levels of power, wherein the scanning strategy is configured to bring each point in the plurality of points to the first temperature and to maintain each point at or above the second maintenance temperature, starting from a time when the point is first scanned until a time when all points in the cross-sectional layer have been scanned; and
controlling scanning of build material using an additive manufacturing apparatus according to the scanning strategy in order to build the cross-sectional layer.
